(19) United States
(12) Patent Application Publication
(10) Pub. No.: US 2023/0083572 A1
(43) Pub. Date: Mar. 16, 2023

(54) CONNECTOR MODULE, COMMUNICATION CABLE WITH CONNECTOR, AND CONNECTOR ASSEMBLY

(71) Applicant: SUMITOMO WIRING SYSTEMS, LTD., Mie (JP)

(72) Inventors: Takuma HIBINO, Mie (JP); Harald LUTSCH, Wolfsburg (DE)

(21) Appl. No.: 17/800,502

(22) PCT Filed: Feb. 9, 2021
(86) PCT No.: PCT/JP2021/004737

§ 371 Date: Aug. 17, 2022

(30) Foreign Application Priority Data
Feb. 21, 2020 (JP) 2020-028762

(51) Int. Cl. H01R 13/6584; H01R 13/52; H01R 13/506

(52) U.S. Cl. CPC H01R 13/6584; H01R 13/5202; H01R 13/506

(57) ABSTRACT

Provided is a connector module provided on an end of a communication cable, the connector module comprising a first terminal, a connector member that houses the first terminal, a tubular shield member that covers the outer circumference of the connector member, and a tubular conductive rubber member disposed in contact with the inner circumferential surface of the shield member, wherein the shield member comprises a housing part in which the conductive rubber member is disposed on the side where the end of the communication cable is inserted, the maximum outer diameter of the conductive rubber member when not compressed by the housing part exceeds the minimum inner dimension of the housing part and is equal to or less than the maximum inner dimension of an opening in the housing part, and at least a portion of the inner circumferential surface of the housing part comprises an inclined surface.

### TECHNICAL FIELD

The present disclosure relates to a connector module, a communication cable with a connector, and a connector assembly.

This application claim priority based on Japanese Patent Application No. 2020-028762 filed Feb. 21, 2020, which is incorporated by reference herein in its entirety.

### BACKGROUND

Recently, for example, high-speed communication at 100 Mbps or more has been desired. A communication cable with a connector used for such high-speed communication is disclosed in Patent Document 1, for example. The communication cable with a connector disclosed in Patent Document 1 is provided with a communication cable including a conductor, and a shield terminal attached to an end of the communication cable. The shield terminal is a connector module provided with a terminal unit and an outer conductor. The terminal unit is provided with an inner conductor that functions as a terminal and a dielectric that functions as a connector member. The outer conductor is a shield member that blocks electromagnetic waves.

In the configuration disclosed in FIG. 1 of Patent Document 1, the shield terminal is housed in a first housing. A rubber stopper for watertightness is fitted into the end of the first housing on the communication cable side.

### PRIOR ART DOCUMENT

### Patent Document

Patent Document 1: JP 2018-152174 A

### SUMMARY OF THE INVENTION

A connector module according to the present disclosure is

a connector module provided on an end of a communication cable, the connector module including:

a first terminal;

a connector member that houses the first terminal;

a tubular shield member that covers the outer circumference of the connector member; and

a tubular conductive rubber member disposed in contact with the inner circumferential surface of the shield member, wherein

the shield member includes a housing part in which the conductive rubber member is disposed on the side where the end of the communication cable is inserted,

the maximum outer diameter of the conductive rubber member when not compressed by the housing part exceeds the minimum inner dimension of the housing part and is equal to or less than the maximum inner dimension of an opening in the housing part,

at least a portion of the inner circumferential surface of the housing part has an inclined surface, and

the inclined surface is inclined such that the inner dimension of the housing part decreases in size proceeding inward into the shield member from the opening.

A communication cable with a connector according to the present disclosure includes:

the connector module according to the present disclosure; and

a communication cable, wherein

the communication cable includes a conductor, an insulating layer, a shielding layer, and a sheath in order from the inside out,

the first terminal is connected to the conductor, and

the conductive rubber member is disposed in contact with the shielding layer.

A connector assembly according to the present disclosure includes:

the communication cable with a connector according to the present disclosure;

a tubular watertight plug mounted onto the outer circumferential surface of the sheath; and

an outer housing that houses the end of the communication cable with a connector and the watertight plug.

### BRIEF DESCRIPTION OF THE DRAWINGS

FIG. 1 is a perspective view of a communication cable with a connector including a connector module according to Embodiment 1.

FIG. 2 is an exploded perspective view illustrating a portion of the communication cable with a connector according to Embodiment 1.

FIG. 3 is an exploded perspective view illustrating an exploded portion of a connector member provided in the connector module according to Embodiment 1.

FIG. 4 is a schematic sectional view, taken along the line IV-IV illustrated in FIG. 1, of the communication cable with a connector according to Embodiment 1.

FIG. 5 is a schematic sectional view, taken along the line V-V illustrated in FIG. 1, of the communication cable with a connector according to Embodiment 1.

FIG. 6A is a schematic sectional view, taken along the line VI-VI illustrated in FIG. 1, of the communication cable with a connector according to Embodiment 1.

FIG. 6B is a diagram for explaining the dimensional relation between a shield member and a conductive rubber member provided in Embodiment 1.

FIG. 6C is an explanatory diagram illustrating an enlarged view of the portion denoted by the dashed-line circle in FIG. 6B.

FIG. 7 is a perspective view of the shield member provided in the connector module according to Embodiment 1.

FIG. 8 is a perspective view of the shield member illustrated in FIG. 7 as seen from the opposite side.

FIG. 9 is a perspective view of a housing of the connector member provided in the connector module according to Embodiment 1.

FIG. 10 is a perspective view of the housing illustrated in FIG. 9 as seen from the opposite side.

FIG. 11 is a perspective view of a cover of the connector member provided in the connector module according to Embodiment 1.

FIG. 12 is a perspective view of the cover illustrated in FIG. 11 as seen from the opposite side.

FIG. 13 is a cross section of a communication cable with a connector including the connector module according to Embodiment 1.

FIG. 14 is a perspective view of a first terminal provided in the connector module according to Embodiment 1.

FIG. 15 is a perspective view as seen from the flat spring side, the view being obtained by rotating the first terminal illustrated in FIG. 14.

FIG. 16 is a perspective view of a housing of the connector member provided in the connector module according to Modification 4.

FIG. 17 is a perspective view of a cover of the connector member provided in the connector module according to Modification 4.

FIG. 18 is a transverse section of a communication cable with a connector including the connector module according to Modification 4.

FIG. 19 is a schematic configuration diagram of a connector assembly according to Modification 5 including the connector module according to Embodiment 1.

### DETAILED DESCRIPTION TO EXECUTE THE INVENTION

### Technical Problem

An improvement in the ease of assembly of a communication cable with a connector is desirable. In particular, in the case where a connector module includes a rubber member, it is desirable to be able to easily fit the rubber member into a prescribed housing location.

Accordingly, one objective of the present disclosure is to provide a connector module with excellent ease of assembly. Another objective of the present disclosure is to provide a communication cable with a connector and a connector assembly with excellent ease of assembly.

### Advantageous Effects of Present Disclosure

The connector module, communication cable with a connector, and connector assembly according to the present disclosure are exceptionally easy to assemble.

### Description of Embodiments of Present Disclosure

First, the content of the embodiments of the present disclosure is listed below.

(1) A connector module according to an embodiment of the present disclosure is

a connector module provided on an end of a communication cable, the connector module including:

a first terminal;

a connector member that houses the first terminal;

a tubular shield member that covers the outer circumference of the connector member; and

a tubular conductive rubber member disposed in contact with the inner circumferential surface of the shield member, wherein

the shield member includes a housing part in which the conductive rubber member is disposed on the side where the end of the communication cable is inserted,

the maximum outer diameter of the conductive rubber member when not compressed by the housing part exceeds the minimum inner dimension of the housing part and is equal to or less than the maximum inner dimension of an opening in the housing part,

at least a portion of the inner circumferential surface of the housing part has an inclined surface, and

the inclined surface is inclined such that the inner dimension of the housing part decreases in size proceeding inward into the shield member from the opening.

As described below, in the connector module according to the present disclosure, (a) the conductive rubber member is disposed easily on the outer circumference of the shielding layer of the communication cable. Moreover, in the connector module according to the present disclosure, (b) the conductive rubber member is inserted easily into the housing part of the shield member. As a result of (a) and (b) above, the connector module according to the present disclosure is exceptionally easy to assemble.

In the state in which the connector module according to the present disclosure is provided on an end of the communication cable, the conductive rubber member is attached to the outer circumference of the shielding layer of the communication cable. Additionally, the conductive rubber member is fitted into the housing part of the shield member.

The conductive rubber member is elastic. Consequently, the conductive rubber member can be expanded radially and thereby easily fitted onto the outer circumference of the shielding layer. Moreover, the maximum outer diameter of the conductive rubber member satisfies the specific size described above. For this reason, the conductive rubber member easily enters the housing part from the opening in the housing part as compared to the case where the inner dimension of the opening in the housing part and its vicinity is the minimum inner dimension, for example. In particular, by using the specific inclined surface described above as a guide, the conductive rubber member easily proceeds inward into the housing part.

Furthermore, as described below, in the connector module according to the present disclosure, (c) the conductive rubber member closely contacts both the shielding layer of the communication cable and the inner circumferential surface of the housing part of the shield member. Due to this close contact, the connector module according to the present disclosure also exhibits excellent electromagnetic shielding properties.

The conductive rubber member closely contacts the shielding layer by elastic deformation when mounted onto the outer circumference of the shielding layer of the communication cable. Due to this close contact, the conductive rubber member and the shielding layer are electrically connected. Also, the conductive rubber member closely contacts the housing part by elastic deformation due to being pressed against at least the inclined surface of the inner circumferential surface of the housing part of the shield member. Due to this close contact, the conductive rubber member and the shield member are electrically connected. Through the above electrical connections, a conductive pathway through the shielding layer, the conductive rubber member, and the shield member is ensured. For this reason, grounding the shield member prevents electrification of the shield member and also causes the shielding layer to be grounded through the conductive rubber member and the shield member. Consequently, an induced current generated in the shielding layer can flow to ground.

(2) In one exemplary aspect of the connector module according to the present disclosure,

the housing part has at least one groove provided in the inclined surface, and

the groove has a shape extending along the axial direction of the shield member.

In this aspect, a portion of the conductive rubber member is fitted into grooves, and the conductive rubber member is firmly held by the shield member. For this reason, the conductive rubber member does not slip off the shield member easily, even if subjected to vibration. Consequently, a rear holder is not necessary, nor does the first terminal need to have a structure for holding the conductive rubber member. In view of these features, this aspect is even easier to assemble. Also, the depth of the grooves increases farther away from the opening in the housing part along the axial direction. Due to such grooves, a large contact area between the conductive rubber member and the shield member is ensured. Accordingly, the conductive rubber member and the shield member are electrically connected more reliably. By making the conductive pathway described above more easily ensured, this aspect has superior electromagnetic shielding properties. Furthermore, although the grooves are included, the shield member has a shape that is moldable in a mold. For this reason, in this aspect, the shield member also has excellent manufacturability.

(3) In one exemplary aspect of the connector module according to (2) above,

the inner circumferential surface includes a plurality of inclined surfaces spaced apart in the circumferential direction of the inner circumferential surface.

In this aspect, an increase in the contact area described above and an improvement in the strength with which the shield member holds the conductive rubber member can be expected.

(4) In one exemplary aspect of the connector module according to (3) above,

the inner circumferential surface includes two inclined surfaces facing each other.

In this aspect, the conductive rubber member is caught between two inclined surfaces and also worked into the grooves. For this reason, a further increase in the contact area described above and a further improvement in the holding strength described above can be expected.

(5) In one exemplary aspect of the connector module according to the present disclosure,

the conductive rubber member is a cylindrical material having a uniform outer diameter.

In this aspect, the outer circumferential surface of the conductive rubber member and the inclined surface of the shield member easily make surface contact with each other. For this reason, a further increase in the contact area described above can be expected. Also, in this aspect, if the conductive rubber member is extruded, the manufacturing costs can be lowered in comparison to the case of molding the conductive rubber member in a mold.

(6) In one exemplary aspect of the connector module according to (5) above,

the conductive rubber member is an extrusion-molded article.

In this aspect, by cutting the elongated body formed by extrusion, the conductive rubber member can be mass-produced. In view of this feature, manufacturing costs can be lowered in this aspect.

(7) In one exemplary aspect of the connector module according to the present disclosure,

the conductive rubber member contains silicone rubber.

In this aspect, elastic deformation of the conductive rubber member is easy. For this reason, in this aspect, the effects of (a) to (c) described above are easily obtained.

(8) In one exemplary aspect of the connector module according to (7) above,

the conductive rubber member contains a conductive filler.

In this aspect, the conductive rubber member has a prescribed conductivity due to the conductive filler. For this reason, in this aspect, a favorable electrical connection between the shielding layer and the shield member is ensured by the conductive rubber member.

(9) In one exemplary aspect of the connector module according to the present disclosure,

the shield member is a casting.

If the shield member is a casting, the shield member can be formed as a singular object rather than an assembly of multiple pieces. The singular shield member is easily attached to the connector member. In view of this feature, this aspect is even easier to assemble. In addition, the singular shield member does not have holes in the circumferential surface of the shield member. In view of this feature, this aspect has superior electromagnetic shielding properties.

(10) A communication cable with a connector according to an embodiment of the present disclosure includes:

the connector module according to any one of (1) to (9) above; and

a communication cable, wherein

the communication cable includes a conductor, an insulating layer, a shielding layer, and a sheath in order from the inside out,

the first terminal is connected to the conductor, and

the conductive rubber member is disposed in contact with the shielding layer.

The communication cable with a connector according to the present disclosure is provided with the connector module according to the present disclosure, and therefore is exceptionally easy to assemble. Also, the communication cable with a connector according to the present disclosure also exhibits excellent electromagnetic shielding properties. Such a communication cable with a connector according to the present disclosure can be used suitably for high-speed communication.

(11) In one exemplary aspect of the communication cable with a connector according to the present disclosure,

the first terminal includes a tubular part that accepts the insertion of a male terminal and a connecting part connected to the conductor,

the tubular part includes a flat spring that presses against the outer circumferential surface of the male terminal inserted into the tubular part, and

the outer circumferential surface of the tubular part includes the outer surface of the flat spring.

In this aspect, the flat spring forms a portion of the tubular part. Such a first terminal has superior manufacturability compared to a conventional female terminal as described later.

(12) In one exemplary aspect of the communication cable with a connector according to the present disclosure,

the communication cable is a shielded twisted-pair cable.

A twisted-pair cable is a communication cable used for differential communication suited to high-speed data communication. In particular, a shielded twisted-pair cable is less susceptible to noise. Consequently, this aspect can be used suitably for high-speed communication at 100 Mbps or more.

(13) In one exemplary aspect of the communication cable with a connector according to the present disclosure,

a constituent material of the connector member is a resin,

the connector member includes a clamp that bites into the communication cable, and

the clamp projects out from the inner circumferential surface of the connector member toward the communication cable.

By causing the clamp to bite into the communication cable, the connector member is firmly secured to the end of the communication cable. Consequently, a crimping ring described later is unnecessary. In view of this feature, this aspect is even easier to assemble.

(14) A connector assembly according to an embodiment of the present disclosure includes:

the communication cable with a connector according to any one of claims 10) to (13), wherein

a tubular watertight plug mounted onto the outer circumferential surface of the sheath; and

an outer housing that houses the end of the communication cable with a connector and the watertight plug.

The connector assembly according to the present disclosure is provided with the communication cable with a connector according to the present disclosure, and therefore is exceptionally easy to assemble. In addition, the connector assembly according to the present disclosure also exhibits excellent electromagnetic shielding properties and watertightness. Such a connector assembly according to the present disclosure can be used suitably for high-speed communication.

(15) In one exemplary aspect of the connector assembly according to the present disclosure,

the watertight plug has a cable hole through which the communication cable is inserted,

the cable hole has a narrow-diameter portion that closely contacts the shielding layer and a wide-diameter portion that closely contacts the sheath, and

the end face of the sheath is caught on a step between the narrow-diameter portion and the wide-diameter portion.

In this aspect, the watertight plug is attached directly to the communication cable. For this reason, a holder for securing the watertight plug is unnecessary. In view of this feature, this aspect is even easier to assemble.

### Detailed Description of Embodiments of Present Disclosure

Specific examples of a connector module, communication cable with a connector, and connector assembly according to embodiments of the present disclosure will be described hereinafter with reference to the drawings. Identical reference signs in the drawings denote identically-named components. Note that the present invention is indicated by the claims and is not limited by the following examples, and all modifications within the scope of the claims and their equivalents are to be included in the scope of the present invention.

### Embodiment 1

[Communication Cable with Connector]

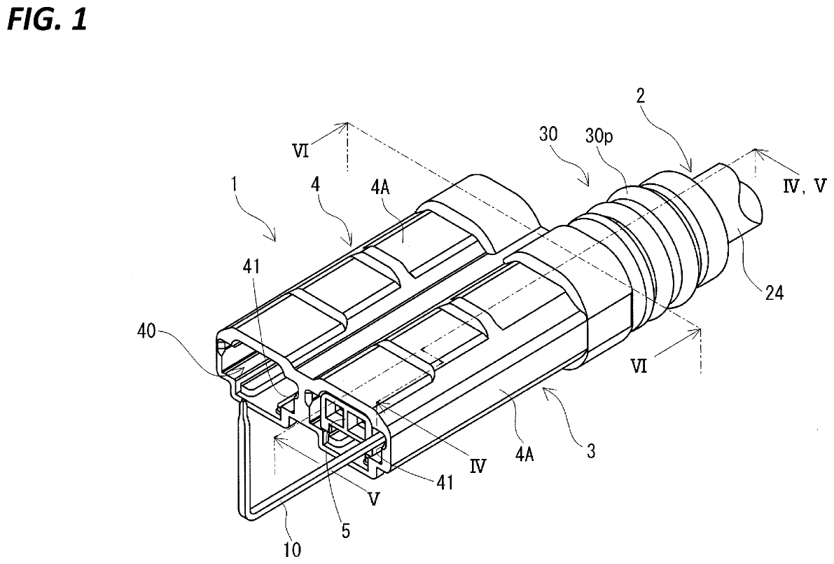

In the present example, a communication cable 1 with a connector to be used for high-speed wired communication in an automobile will be described on the basis of FIGS. 1 to 15.

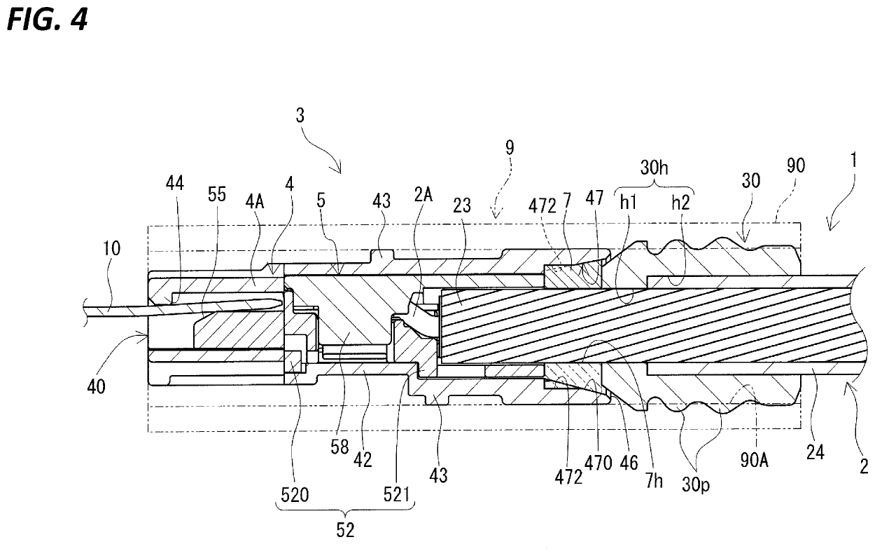

FIGS. 1 and 4 illustrate an earth terminal 10 extending from a circuit board of an in-vehicle device in addition to the communication cable 1 with a connector. The circuit board is omitted from illustration.

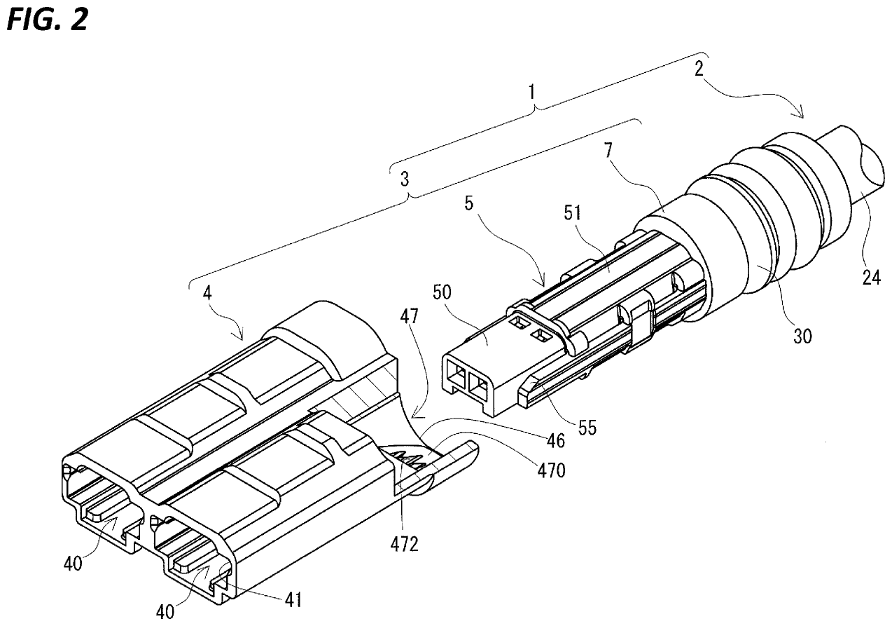

FIG. 2 illustrates a portion of a shield member 4 in which the area near an opening 46 is cut away. As a result, a portion of the inner circumferential surface of a housing part 47 is visible.

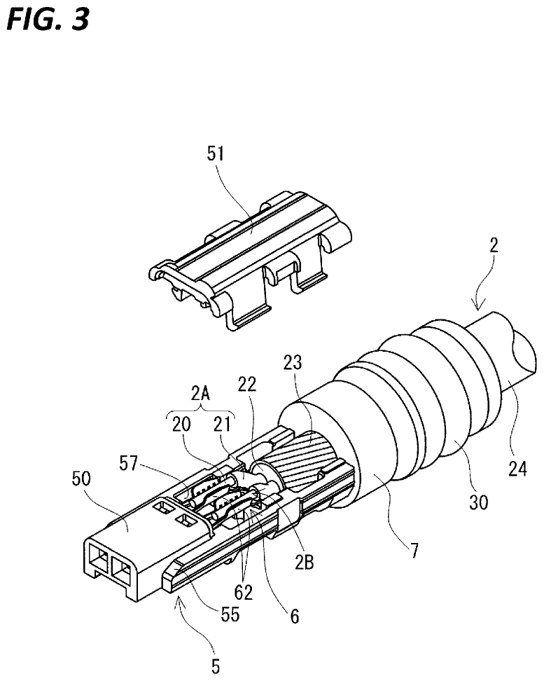

FIGS. 3, 14, and 15 illustrate states in which a wire barrel 62 is open in a first terminal 6 described later. When the communication cable 1 with a connector is in the assembled state, the wire barrel 62 is in a folded state, or in other words a closed state.

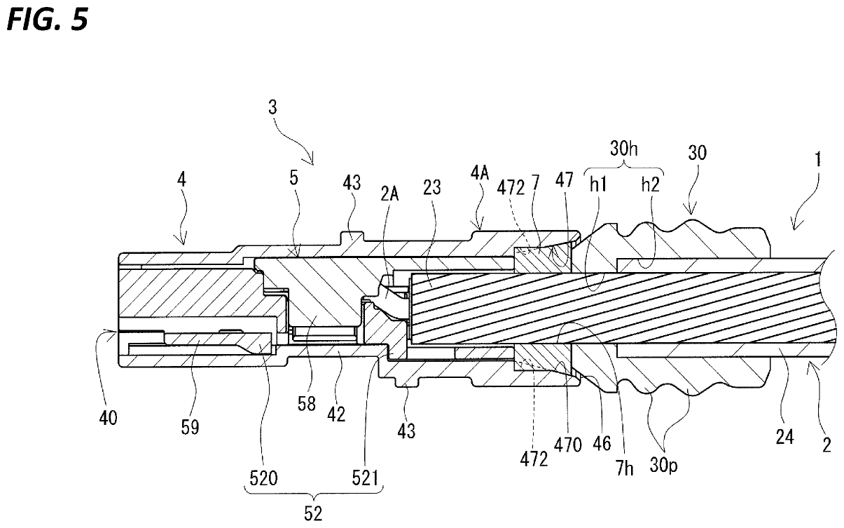

FIGS. 4 and 5 do not illustrate sectional views but rather external views of a shielding layer 23 of a communication cable 2. Also, in FIG. 4, the upper half of a conductive rubber member 7 is illustrated with solid lines while the lower half is illustrated virtually with chain double-dashed lines. For this reason, a groove 472 is visible in the lower half of the housing part 47 illustrated in FIG. 4. In actuality, as illustrated in FIG. 5, the conductive rubber member 7 gets into the groove 472 in the lower half, similarly to the groove 472 in the upper half.

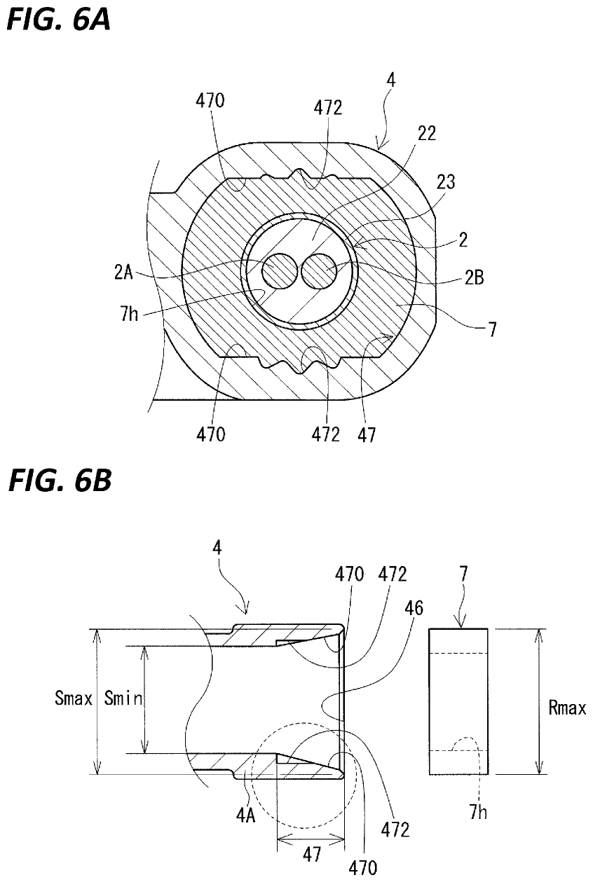

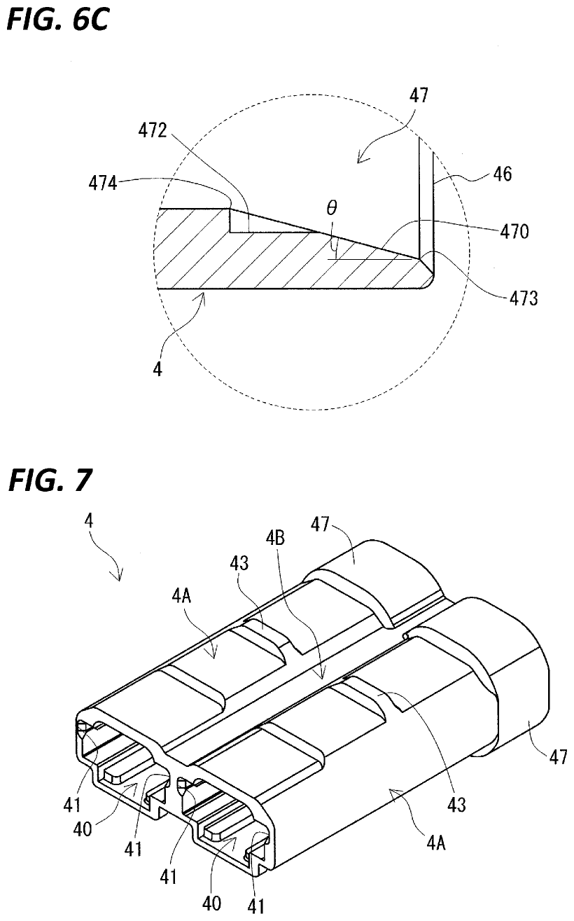

FIG. 6A is a sectional view of the communication cable 1 with a connector taken in the direction orthogonal to the longitudinal direction of the communication cable 1 with a connector. The sectional position of FIG. 6A is the position where the conductive rubber member 7 is provided in the communication cable 1 with a connector. In FIG. 6A, the conductive rubber member 7 has been fitted into the housing part 47 of the shield member 4. In this state, the outer circumferential surface of the conductive rubber member 7 is pressed in the radially-inward direction of the conductive rubber member 7 by the inner circumferential surface of the housing part 47.

FIG. 6B illustrates a portion of the shield member 4, illustrating a sectional view of the area near the housing part 47 taken in the longitudinal direction described above and an external view of the conductive rubber member 7. In FIG. 6B, the conductive rubber member 7 has not been fitted into the housing part 47.

Note that the vertical direction in FIGS. 1 to 6B is not necessarily aligned with up and down in the automobile.

Also, in this specification, a cross section refers a sectional view taken in the plane orthogonal to the axial or longitudinal direction of the communication cable 1 with a connector and each member such as the shield member 4.

(Overview)

As illustrated in FIG. 1, the communication cable 1 with a connector according to Embodiment 1 is provided with a communication cable 2 and a connector module 3. The connector module 3 is provided on an end of the communication cable 2. The communication cable 1 with a connector in the present example is a pigtail cable. A pigtail cable is a cable in which the connector module 3 is provided on one end of the communication cable 2. Unlike the present example, the communication cable 1 with a connector may also be a jumper cable. A jumper cable is provided with the connector module 3 on both ends of the communication cable 2.

As illustrated in FIGS. 1 to 3, the connector module 3 is provided with a first terminal 6, a connector member 5, a shield member 4, and a conductive rubber member 7. The first terminal 6 is housed inside the connector member 5 (FIG. 3). The connector member 5 is covered by the shield member 4 (FIG. 1). The conductive rubber member 7 is fitted into the end of the shield member 4 on the side where the communication cable 2 is inserted (FIGS. 2, 4). In this way, the connector module 3 is configured.

In particular, in the connector module 3 of Embodiment 1, the shield member 4 is provided with a housing part 47, as illustrated in FIGS. 2, 4, and 5. The housing part 47 is the portion where the conductive rubber member 7 is disposed in the shield member 4. At least a portion of the inner circumferential surface forming the housing part 47 has a specific inclined surface 470 described later (see also FIG. 6B). As described later, the outer dimensions of the conductive rubber member 7 and the inner dimensions of the housing part 47 satisfy a specific relationship such that a maximum outer diameter Rmax of the conductive rubber member 7 exceeds a minimum inner dimension Smin of the housing part 47 and is equal to or less than a maximum inner dimension Smax of the housing part 47 (FIG. 6B). The communication cable 1 with a connector of Embodiment 1 is provided with the connector module 3 of Embodiment 1.

In the following, the configuration of the communication cable 2 will be described first. Thereafter, a detailed configuration of the connector module 3 will be described.

(Communication Cable)

The communication cable 2 in the present example is used for communication at 100 Mbps or more. The communication cable 2 in the present example is not particularly limited insofar as communication speeds of 100 Mbps or more can be ensured. The communication speed of the communication cable 2 is preferably equal to or greater than 1 Gbps. The communication cable 2 in the present example is a twisted-pair cable conforming to the Ethernet(R) standard. A twisted-pair cable is suitable for differential communication that is less susceptible to noise.

In particular, the communication cable 2 in the present example is a shielded twisted-pair (STP) cable. A shielded twisted-pair cable is even less susceptible to noise due to a shielding layer 23 described later. Accordingly, the connector module 3 provided with a shielded twisted-pair cable is suitable for use with high-speed communication at 100 Mbps or more, and even 1 Gbps or more.

As illustrated in FIG. 3, the communication cable 2 in the present example is provided with a conductor 20, an insulating layer 21, a shielding layer 23, and a sheath 24 in order from the inside out. Specifically, the shielded twisted-pair cable is provided with two electric wires 2A, 2B twisted together. Each of the electric wires 2A, 2B is provided with the conductor 20 and the insulating layer 21 that covers the outer circumference of the conductor 20. The two electric wires 2A, 2B twisted together are bundled into one by an intervening layer 22. Moreover, the shielded twisted-pair cable includes the shielding layer 23 provided on the outer circumference of the intervening layer 22 and the sheath 24 that covers the outer circumference of the shielding layer 23.

The shielding layer 23 provides electromagnetic shielding. The shielding layer 23 is formed from a braided mesh of a metal such as copper, copper alloy, or aluminum alloy, for example. The sheath 24 is formed from an insulating resin such as polyvinyl chloride or polyethylene, for example.

The end of the communication cable 2 is progressively stripped. Specifically, the shielding layer 23 is exposed from the sheath 24 at the end of the communication cable 2. The intervening layer 22 is exposed from the shielding layer 23. The electric wires 2A, 2B are exposed from the intervening layer 22. At the leading end of each of the exposed electric wires 2A, 2B, the conductor 20 is exposed from the insulating layer 21. The first terminal 6 is attached to each conductor 20.

(Connector Module)

Hereinafter, the components of the connector module 3 will be described in the order of the shield member 4, the conductive rubber member 7, the connector member 5, and the first terminal 6.

<Shield Member>

<<Overview>>

The shield member 4 is provided with a tubular body 4A, as illustrated in FIG. 1. The tubular body 4A covers the outer circumference of the connector member 5. By covering the connector member 5, the shield member 4 provides shielding from electromagnetic waves radiated from the first terminal 6 (FIG. 3) and the conductors 20 (FIG. 3) of the communication cable 2, and from electromagnetic waves originating outside the shield member 4. The shield member 4 is grounded by being in contact (FIG. 4) with the earth terminal 10 illustrated in FIG. 1. This grounding prevents electrification of the shield member 4 itself. In addition, the shield member 4 is electrically connected to the shielding layer 23 of the communication cable 2 through the conductive rubber member 7 (FIGS. 4, 5). For this reason, the shielding layer 23 is also grounded by the earth terminal 10 through the conductive rubber member 7 and the shield member 4.

<<Overall Configuration>>

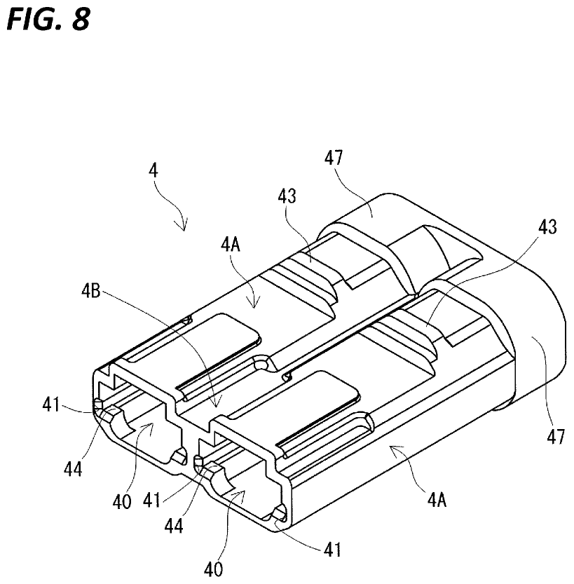

As illustrated in FIGS. 7 and 8, the shield member 4 in the present example is provided with two tubular bodies 4A and a connecting part 4B. The two tubular bodies 4A are arranged side by side with the axes parallel to each other. The connecting part 4B is provided between the two tubular bodies 4A and connects the tubular bodies 4A along the axial directions thereof. The shield member 4 is a singular object in which the two tubular bodies 4A and the connecting part 4B are unified.

The two tubular bodies 4A are both provided with a continuous circumferential wall. The circumferential wall does not have holes penetrating through the inside and outside of the circumferential wall. Additionally, each tubular body 4A is long enough to accommodate an entire connector member 5 inside the tubular body. The connecting part 4B is a wall that partitions the adjoining tubular bodies 4A, so to speak. Note that FIG. 1 illustrates a state in which the connector member 5 and the conductive rubber member 7 are housed in one of the tubular bodies 4A. In actuality, when the communication cable 1 with a connector is in the assembled state, one connector member 5 and one conductive rubber member 7 are housed in each of the tubular bodies 4A.

The shield member 4 in the present example has a function of bundling two communication cables 2 into one and a function of collectively shielding the ends of the two communication cables 2 from electromagnetic waves. Unlike the present example, the shield member 4 may also be formed from a single tubular body 4A. Alternatively, the shield member 4 may also be formed by connecting three or more tubular bodies 4A with respective connecting parts 4B.

<<Communication Cable Side>>

As illustrated in FIGS. 4 to 6B, the housing part 47 is provided on the side of the shield member 4 where the end of the communication cable 2 is inserted into each tubular body 4A. The housing part 47 is provided with an opening 46. The opening 46 opens on the communication cable 2 side of the tubular body 4A. The conductive rubber member 7 disposed on the outer circumference of the shielding layer 23 exposed on the communication cable 2 is fitted into the housing part 47 from the opening 46. Consequently, the inner region shaped by the inner circumferential surface of the housing part 47 has a volume sufficient to house the conductive rubber member 7. In the present example, the cross-sectional area of the inner region of the housing part 47 is large compared to the cross-sectional area of the inner region other than the housing part 47 in the shield member 4. Note that the cross-sectional area of the inner region of the shield member 4 including the housing part 47 is the area of the section, taken in the direction orthogonal to the longitudinal direction of the shield member 4, of the inner region shaped by the inner circumferential surface of the shield member 4.

In the present example, the inner circumferential surface of the housing part 47 and the inner circumferential surface of the region continuous with the housing part 47 in the shield member 4 are connected so as to form an obtuse angle. This obtuse angle varies depending on the inclination angle θ (FIG. 6C) of the inclined surface 470 described later. Also, in the present example, the housing part 47 is long enough to accommodate the entire conductive rubber member 7 inside the housing part 47.

In the present example, the shape and cross-sectional shape of the opening 46 in the housing part 47 is a racetrack shape (FIG. 6A). A racetrack shape herein refers to a shape having a pair of straight portions and a pair of arc-shaped portions. The straight portions are disposed in parallel and have the same length. The straight portions are mainly formed by the inclined surfaces 470. The arc-shaped portions join the edges of the straight portions to one another.

The inner circumferential shape of the housing part 47 is such that the cross-sectional area gradually decreases proceeding inward into the tubular body 4A from the opening 46 (FIG. 6B). For this reason, the innermost end 474 (FIG. 6C) of the housing part 47 has a minimum inner dimension Smin The opening 46 in the housing part 47 has a maximum inner dimension Smax. The inner dimension of the housing part 47 herein is the diameter of the largest circle inscribed in the inner circumferential surface of the housing part 47 in a cross section of the tubular body 4A. The location where the diameter of the largest circle is taken on the inner circumferential surface of the housing part 47 is typically the location where the diameter is the distance between the portions sandwiching the conductive rubber member 7. In the present example, the distance is the distance between the two inclined surfaces 470. The minimum inner dimension Smin in the present example is the minimum value of the inner dimension of the housing part 47. The maximum inner dimension Smax also depends on the cable gauge, but may be approximately equal to or greater than (minimum inner dimension Smin+0.5 mm) and less than or equal to (minimum inner dimension Smin+2.0 mm), for example.

At least a portion of the inner circumferential surface of the housing part 47 is provided with the inclined surface 470 (see also FIG. 2). As illustrated in FIG. 6B, the inclined surface 470 is inclined such that the inner dimension of the housing part 47 decreases proceeding inward into the tubular body 4A of the shield member 4 from the opening 46. In the present example, the inner circumferential surface of the housing part 47 is provided with a plurality of inclined surfaces 470 spaced apart in the circumferential direction of the inner circumferential surface. Also, in the present example, the inner circumferential surface of the housing part 47 is provided with two inclined surfaces 470 arranged to face each other.

Specifically, each inclined surface 470 is provided continuously from near the opening 46 to the inner end 474 described above. In other words, each inclined surface 470 is provided throughout the entire length of the tubular body 4A in the axial direction in the region of the shield member 4 where the conductive rubber member 7 is housed (FIGS. 4, 5). Such inclined surfaces 470 can be used as guides for leading the conductive rubber member 7 inward into the tubular body 4A.

Note that the inclined surfaces 470 may also be provided in only a portion of the tubular body 4A in the axial direction in the region of the shield member 4 where the conductive rubber member 7 is housed. In one example, the housing part 47 is provided with the inclined surfaces 470 only in a region near the opening 46, and the region positioned on the inner side of the tubular body 4A past the inner ends of the inclined surfaces 470 is the region having the minimum inner dimension Smin However, with the configuration of the present example described above, a large contact area between the conductive rubber member 7 and the housing part 47 is ensured easily. In other words, a large conductive pathway between the conductive rubber member 7 and the housing part 47 is ensured easily. In view of this feature, the configuration of the present example described above is preferable.

The inclination angle θ of the inclined surfaces 470 with respect to the tubular body 4A can be selected appropriately. As illustrated in FIG. 6C, the inclination angle θ is the angle obtained by the straight line connecting an end 473 near the opening 46 to the inner end 474 of the inclined surfaces 470, and a straight line parallel to the axis. The larger the inclination angle θ is, the smaller the inner dimension of the housing part 47 is. Accordingly, the inclined surfaces 470 press against the conductive rubber member 7 easily. As a result, close contact between the inclined surfaces 470 and the conductive rubber member 7 is achieved easily. This close contact increases the reliability of the conductive state between the conductive rubber member 7 and the shield member 4. The smaller the inclination angle θ is, the larger the inner dimension of the housing part 47 is. Accordingly, the conductive rubber member 7 enters the housing part 47 easily. In view of this feature, an improvement in ease of assembly is attained. From the standpoint of ensuring good conductivity, the inclination angle θ is preferably selected within a range in which ease of assembly is not impaired. For example, the inclination angle θ may be equal to or greater than 5° and less than or equal to 30°. In the present example, the inclination angle θ is equal to or greater than 5° and less than or equal to 30°.

In the case where a plurality of inclined surfaces 470 are provided, the inclined surfaces 470 may have the same or different inclination angles θ. In the present example, the inclined surfaces 470 have different inclination angles θ.

In the case where a plurality of inclined surfaces 470 are provided, the number of inclined surfaces 470 can be selected appropriately. Although there are two inclined surfaces 470 in the present example, there may also be three or more. Also, in the case where a plurality of inclined surfaces 470 are provided, the arrangement of the inclined surfaces 470 on the inner circumferential surface of the housing part 47 and the spacing between adjacent inclined surfaces 470 can be selected appropriately. Preferably, the inclined surfaces 470 are disposed at positions equally dividing the inner circumferential surface of the housing part 47 in the circumferential direction like in the present example, since the inclined surfaces 470 easily press against the conductive rubber member 7 uniformly. In particular, if a plurality of inclined surfaces 470 are arranged facing each other like in the present example, two facing inclined surfaces 470 can press against the conductive rubber member 7 sandwiched in between. Through this pressing, the conductive rubber member 7 closely contacts the housing part 47. For this reason, a favorable conductive pathway between the conductive rubber member 7 and the shield member 4 is ensured. Moreover, the conductive rubber member 7 is sandwiched between the inclined surfaces 470 and thereby firmly held in the shield member 4.

The inclined surfaces 470 may be flat, planar surfaces, but preferably have an uneven shape. Specifically, the housing part 47 preferably has at least one groove 472 provided in the inclined surfaces 470 like in the present example.

The number of grooves 472 in a single inclined surface 470, the length, depth, cross-sectional shape, and formation direction of each groove 472, the spacing between adjacent grooves 472, and the like can be selected appropriately. The more grooves 472 there are, the longer the grooves 472 are, and the deeper the maximum depth of the grooves 472 is, the more the contact area with the conductive rubber member 7 in the housing part 47 is increased. This is because the elastically deformed conductive rubber member 7 gets into the grooves 472. Due to this increase in the contact area, the conductive pathway between the conductive rubber member 7 and the shield member 4 is ensured. Consequently, the reliability of the conductive state is increased. In addition, the strength with which the shield member 4 holds the conductive rubber member 7 is increased.

In the present example, as illustrated in FIGS. 2 and 6B, the grooves 472 have a shape extending along the axial direction of the shield member 4. In this case, the shield member 4 has the grooves 472, but is moldable in a mold. Accordingly, the shield member 4 can be manufactured easily. Also, in this case, the depth of the grooves 472 varies along the axial direction. Specifically, the thickness of the portions of the housing part 47 where the inclined surfaces 470 are formed varies so as to become thicker farther away from the opening 46 in the housing part 47 along the axial direction. Along with this change in thickness, the depth of the grooves 472 increases farther away from the opening 46 in the housing part 47 along the axial direction. For this reason, the contact area described above increases easily. The maximum depth of each groove 472 may be equal to or greater than 40% and less than or equal to 80% of the maximum thickness of the portions where the inclined surfaces 470 are formed. From the standpoint of increasing the contact area and improving the holding strength described above, the maximum depth of each groove 472 is preferably equal to or greater than 50% and less than or equal to 70% of the maximum thickness like in the present example.

In the present example, as illustrated in FIG. 6A, each inclined surface 470 is provided with a plurality of grooves 472 with a prescribed spacing in the circumferential direction of the tubular body 4A (see also FIG. 2). The cross section of each groove 472 is V-shaped.

Also, in the present example, as illustrated in FIGS. 6B and 6C, each groove 472 is provided continuously in each inclined surface 470 from an intermediate position some distance away from the opening 46 to the inner end 474 described above. For this reason, the conductive rubber member 7 easily enters the housing part 47, with the region from the opening 46 to the intermediate position in each inclined surface 470 acting as a guide. In each inclined surface 470, the region of the tubular body 4A farther inward than the intermediate position, or in other words the region where the grooves 472 are provided, contributes to an increase in the contact area and an improvement in the holding strength. Note that at least one groove 472 may also be provided throughout the entire length of the inclined surfaces 470 in the axial direction.

In the case where a plurality of grooves 472 are provided, the grooves 472 may have the same specifications, such as the length, depth, formation direction, and cross-sectional shape, for example, or at least one of the specifications may be different like in the present example. Also, in the case where a plurality of inclined surfaces 470 are provided, at least one of the number of grooves 472 in each inclined surface 470 or the specifications of the grooves 472 may be the same, or different like in the present example. In the present example, among the plurality of grooves 472 provided in each inclined surface 470, the maximum depth of the groove 472 positioned in the middle in the groove arrangement direction is deeper than the maximum depth of the grooves 472 positioned on either side in the groove arrangement direction (FIG. 6A). With such a housing part 47, the magnitude of the pressing by the inner circumferential surface of the housing part 47 against the conductive rubber member 7 is easily made uniform in the circumferential direction of the conductive rubber member 7. In a manner of speaking, the magnitude of the compression of the conductive rubber member 7 along the circumferential direction is easily made uniform. Consequently, the conductive rubber member 7 easily enters the housing part 47 while a large contact area with the housing part 47 is also ensured.

Otherwise, in the present example, the end face of each groove 472 on the first terminal 6 side, or in other words, the end face on the inner end 474 side, is disposed orthogonally to the axial direction of the shield member 4. For this reason, the end face of each groove 472 on the first terminal 6 side functions as a stopper for the conductive rubber member 7 when the conductive rubber member 7 is press-fitted into the housing part 47.

<<Mating Terminal Side>>

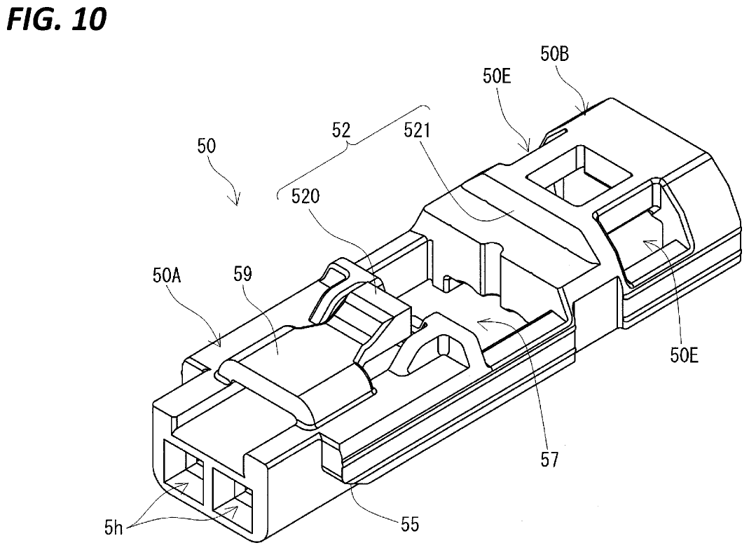

In the present example, as illustrated in FIGS. 4 and 5, a shield-side engaging part 42 is provided inside each tubular body 4A on the side where a mating terminal is inserted. The shield-side engaging part 42 engages with the outer circumference of the connector member 5. The shield-side engaging part 42 in the present example is a raised section that projects out from the inner circumferential surface of the shield member 4 toward the connector member 5 side. The shield-side engaging part 42 has a certain length along the axial direction of the tubular body 4A. The shield-side engaging part 42 is fitted into the space between an elastic protrusion 520 and a stepped portion 521 of a connector-side engaging part 52. The connector-side engaging part 52 is provided on the outer circumference of a housing 50 (FIG. 10) described later of the connector member 5. The engagement between the shield-side engaging part 42 and the connector-side engaging part 52 will be described later. Unlike the present example, the shield-side engaging part 42 may also be a recessed section.

As illustrated in FIGS. 7 and 8, first guide parts 41 are provided in an opening 40 through which the mating terminal is inserted in the shield member 4. The first guide parts 41 are configured by gradually reducing the thickness of the shield member 4 proceeding in the axial direction from the inner side of the tubular body 4A toward the opening 40. By providing the first guide parts 41 at positions corresponding to the earth terminal 10 (FIG. 1) in the opening 40, the earth terminal 10 is guided into the tubular body 4A. By disposing the first guide parts 41 in the opening 40, an existing earth terminal 10 provided on a circuit board of an in-vehicle device can be used as-is to ground the shield member 4. Consequently, grounding the shield member 4 does not necessitate any special design changes to the circuit board.

As illustrated in FIGS. 4 and 8, overhanging parts 44 are provided near the first guide parts 41 at the opening 40. The overhanging parts 44 are configured by having a portion of the inner circumferential surface of the tubular body 4A project out. The overhanging parts 44 project inward into the tubular body 4A. Additionally, the overhanging parts 44 are provided at positions offset in the axial direction of the tubular body 4A with respect to second guide parts 55 (FIG. 4) of the connector member 5 described later. The overhanging parts 44 and the second guide parts 55 hold the earth terminal 10 inserted into the tubular body 4A so as to mesh with each other from either side of the earth terminal 10. Due to this meshing, the overhanging parts 44 and the second guide parts 55 contact the outer circumferential surface of the earth terminal 10. In other words, the overhanging parts 44 are electrical contacts between the shield member 4 and the earth terminal 10. Also, due to the meshing, a state of contact between the overhanging parts 44 and the earth terminal 10 is firmly maintained.

<<Constituent Material>>

The constituent material of the shield member 4 may be a metal with a high electrical conductivity. In particular, the constituent material is preferably an alloy, more preferably a zinc alloy. Zinc alloys are alloys in which the most abundant element in the alloy is zinc (Zn). Specific zinc alloys include alloys containing, in addition to zinc, at least one element selected from the group consisting of aluminum (Al), magnesium (Mg), iron (Fe), lead (Pb), cadmium (Cd), and tin (Sn). Zinc alloys are a suitable constituent material for the shield member 4 due to their excellent electrical conductivity and strength, and their low cost.

<<Manufacture>>

The shield member 4 may be a casting. A casting is produced by filling a mold with a metal in a molten state, that is, molten metal, and then cooling the mold and the metal. The shield member 4 in the present example is a die-cast material, which is one example of a casting. A die-cast material is produced by forcing molten metal under pressure into a mold. In particular, if the shield member 4 is a casting of a zinc alloy, the thin-walled shield member 4 is produced easily with high dimensional accuracy. This is because molten zinc alloys have low viscosity, making it easy for the molten metal to spread into narrow spaces inside the mold.

The shield member 4 formed from a casting is made thicker more easily than a shield member formed from a stamped article obtained by stamping a sheet material. This is because if the casting is thick to a certain degree, a mold is easily filled with molten metal during the casting process, and the casting is manufactured easily. The thicker the shield member 4 is, the more easily bulky is the shield member 4. For this reason, the minimum value of the thickness of the shield member 4 is preferably equal to or greater than 0.25 mm and less than or equal to 1.0 mm. The minimum value here excludes the position of the inclined surface of the first guide parts 41 and the region near the opening 46. This is because the minimum distance between the inclined surface of the first guide parts 41 and the outer circumferential surface of the shield member 4 and the minimum thickness of the region near the opening 46 may be less than 0.25 mm.

By setting the minimum value of the thickness of the shield member 4 to be equal to or greater than 0.25 mm, the mold is filled with molten metal more easily during the casting of the shield member 4. Also, by setting the minimum value of the thickness of the shield member 4 to be equal to or greater than 0.25 mm, a prescribed strength can be ensured for the shield member 4. Setting the minimum value of the thickness of the shield member 4 to be less than or equal to 1.0 mm keeps the shield member 4 from being bulky and heavy. Consequently, a compact and lightweight shield member 4 is obtained easily. The minimum value of the thickness of the shield member 4 is preferably equal to or greater than 0.3 mm and less than or equal to 0.9 mm, more preferably equal to or greater than 0.3 mm and less than or equal to 0.5 mm

As illustrated in FIGS. 7 and 8, the shield member 4 may be provided with locally thick-walled sections 43. In the present example, the thick-walled sections 43 are formed respectively on the mutually facing surfaces of the shield member 4 illustrated in FIGS. 7 and 8 (see also FIGS. 4 and 5). By providing the shield member 4 with the thick-walled sections 43, the mold is filled with molten metal more easily during the casting of the shield member 4. Moreover, the thick-walled sections 43 increase the strength of the shield member 4.

<Conductive Rubber Member>

As illustrated in FIGS. 3 to 5, the conductive rubber member 7 is a tubular member disposed on the outer circumference of the shielding layer 23 exposed on the communication cable 2 (see also FIG. 6A). The conductive rubber member 7 is provided with a cable hole 7h (see also FIG. 6B). The communication cable 2 is inserted into the cable hole 7h. In the state before the conductive rubber member 7 is mounted onto the shielding layer 23, the inner diameter of the cable hole 7h is smaller than the outer diameter of the shielding layer 23. Consequently, when the conductive rubber member 7 is mounted onto the outer circumference of the shielding layer 23, elastic shrinkage of the conductive rubber member 7 causes the conductive rubber member 7 to closely contact the outer circumferential surface of the shielding layer 23. Also, as illustrated in FIGS. 4 and 5, the conductive rubber member 7 is housed in the housing part 47 of the shield member 4. In the state in which the conductive rubber member 7 is disposed in the housing part 47, at least a portion of the outer circumferential surface of the conductive rubber member 7 is preferably pressed against the inner circumferential surface of the housing part 47. Furthermore, at least a portion of the outer circumferential surface of the conductive rubber member 7 is preferably pressed in the radially inward direction of the conductive rubber member 7 by at least the inclined surfaces 470 of the inner circumferential surface of the housing part 47. The repulsive force of the conductive rubber member 7 in response to this pressing causes the outer circumferential surface of the conductive rubber member 7 to closely contact the inner circumferential surface of the housing part 47. In other words, the conductive rubber member 7 is disposed in contact with both the inner circumferential surface of the housing part 47 and the outer circumferential surface of the shielding layer 23. Due to this close contact, a conductive pathway through the shielding layer 23, the conductive rubber member 7, and the shield member 4 is ensured. For this reason, an induced current generated in the shielding layer 23 flows to ground through the conductive rubber member 7 and the shield member 4 in contact with the earth terminal 10 (FIG. 1).

<<Shape>>

The conductive rubber member 7 in the present example is a cylindrical material having a uniform outer diameter in the axial direction of the conductive rubber member 7. Having a uniform outer diameter in the axial direction means that when a cross section of the conductive rubber member 7 is taken at any position in the axial direction, the outer diameter of the conductive rubber member 7 is the same for all cross sections. If the conductive rubber member 7 is a cylindrical material, the conductive rubber member 7 has a cylindrical outer circumferential surface. When the conductive rubber member 7 is pressed against the inclined surfaces 470 of the shield member 4, at least a portion of the outer circumferential surface of the conductive rubber member 7 and the portions other than the grooves 472 of the inclined surface 470 can make surface contact (FIG. 6A).

<<Dimensions>>

As illustrated in FIG. 6B, the maximum outer diameter Rmax of the conductive rubber member 7 exceeds the minimum inner dimension Smin of the housing part 47 and is less than or equal to the maximum inner dimension Smax of the opening 46 of the housing part 47. The maximum outer diameter Rmax of the conductive rubber member 7 here is the diameter of the following smallest circle in the state in which the conductive rubber member 7 is mounted onto the shielding layer 23 of the communication cable 2 and not compressed by the housing part 47. The smallest circle is the smallest circle inscribed by the outline of the conductive rubber member 7 in a planar view from the axial direction of the cable hole 7h of the conductive rubber member 7. Note that in FIG. 6B, the communication cable 2 is omitted from illustration. The maximum outer diameter Rmax in the present example is the same as the maximum inner dimension Smax.

The ratio (Smin/Rmax) of the minimum inner dimension Smin of the housing part 47 to the maximum outer diameter Rmax of the conductive rubber member 7 may be equal to or greater than 70% and less than or equal to 90%, for example. The greater the ratio is, the more easily smaller is the amount by which the conductive rubber member 7 is compressed by the pressing from the inner circumferential surface of the housing part 47. If the ratio is equal to or greater than 70%, the compression amount is small, and the conductive rubber member 7 enters the housing part 47 easily.

The smaller the ratio, the more easily larger is the compression amount of the conductive rubber member 7. If the ratio is less than or equal to 90%, the compression amount is large, and a large contact area between the conductive rubber member 7 and the housing part 47 is ensured easily. From the standpoint of improving insertability and increasing the contact area, the ratio may also be equal to or greater than 75% and less than or equal to 85%. The ratio in the present example is 79%.

In the present example, the length of the conductive rubber member 7 along the axial direction of the conductive rubber member 7 is roughly equal to the length, along the axial direction of the shield member 4, of the portions of the housing part 47 where the inclined surfaces 470 are formed.

<<Constituent Material>>

Typically, the conductive rubber member 7 is formed from a molded composite material in which a conductive filler is dispersed in a rubber material. The rubber material may be natural rubber or synthetic rubber, for example. The conductive filler may be conductive carbon black or metal powder, for example. The metal powder may be aluminum powder, copper powder, or silver powder, for example. The conductive filler content in the composite material may be adjusted in a range such that a prescribed conductivity can be ensured for the conductive rubber member 7.

In particular, silicone rubber can be used suitably as the rubber material. Silicone rubber is a relatively soft rubber. Accordingly, elastic deformation of the conductive rubber member 7 formed from silicone rubber is easy. The conductive rubber member 7 in the present example is a molded composite material containing silicone rubber and a conductive filler.

<<Manufacture>>

The conductive rubber member 7 may be an extrusion-molded article. In extrusion molding, typically, the composite material is melted by heating and then compressed and extruded through a tool called a die to produce articles continuously. If extrusion molding is used, an elongated material with a desired shape can be produced from the die, and by cutting the elongated material to a prescribed length, the conductive rubber member 7 of the prescribed length can be mass-produced. For this reason, with extrusion molding, a cylindrical member of uniform cross-sectional shape and uniform dimensions in the axial direction can be manufactured efficiently compared to the case where the conductive rubber member 7 is molded in a mold. Consequently, productivity is excellent for the conductive rubber member 7 that is an extrusion-molded article. The conductive rubber member 7 in the present example is an extrusion-molded article.

<<Placement on Communication Cable>>>

As illustrated in FIGS. 4 and 5, the conductive rubber member 7 in the present example covers a portion of the shielding layer 23 exposed from the sheath 24, without covering the entire shielding layer 23. Some of the portion of the shielding layer 23 not covered by the conductive rubber member 7 is covered by a watertight plug 30 described later.

Unlike the present example, the conductive rubber member 7 may also be long enough to reach the outer circumference of the sheath 24 in the axial direction of the communication cable 2. For example, the conductive rubber member 7 and the watertight plug 30 described later may have an integrated form. In the case where the conductive rubber member 7 and the watertight plug 30 are a single piece, the number of components forming the communication cable 1 with a connector is reduced, thereby improving the productivity of the communication cable 1 with a connector. Note that in the case where the conductive rubber member 7 and the watertight plug 30 are a single piece, the rubber member of the single piece is provided with a plurality of annular ridges 30p described later in the portion that functions as the watertight plug 30. The rubber material of such a single piece may be manufactured by molding in a mold rather than extrusion molding.

<Connector Member>

As illustrated in FIG. 3, the connector member 5 houses the first terminal 6 described later. Also, the connector member 5 is housed inside the shield member 4 (FIGS. 1, 4, 5). The connector member 5 in the present example is provided with a housing 50 and a cover 51. The constituent material of the housing 50 and the constituent material of the cover 51 are both electrically insulating materials, typically a resin. The resin may be polybutylene terephthalate, polyamide, or polyethylene. The constituent material of the connector member 5 in the present example is the resin described above.

<<Housing>>

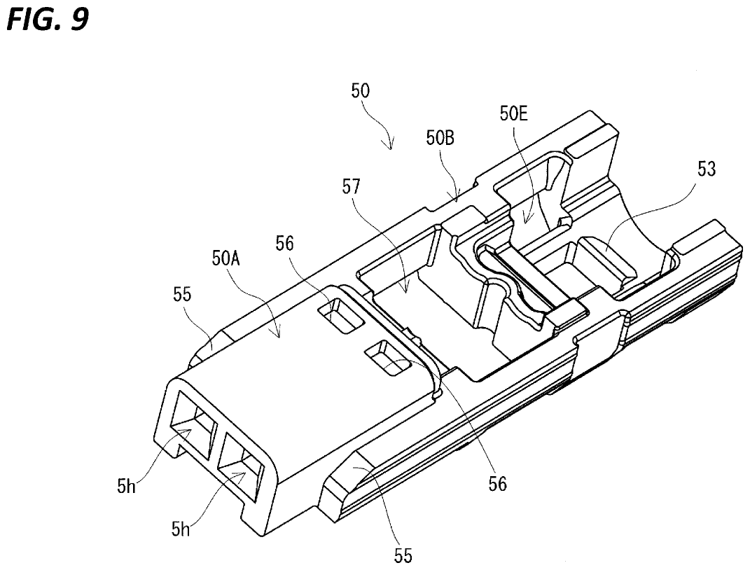

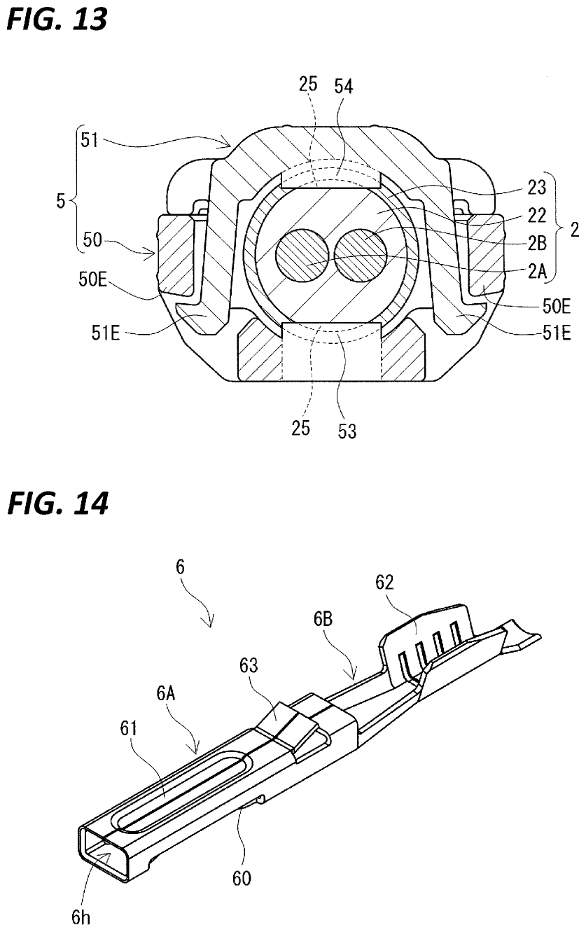

As illustrated in FIGS. 9 and 10, the housing 50 is provided with a connector tube 50A and a base 50B. A tubular part 6A (FIG. 14), which is mainly the leading end of the first terminal 6, is inserted into the connector tube 50A. The base 50B underpins the connection point between the first terminal 6 and the conductor 20 of the communication cable 2 (FIG. 3). The base 50B is open on the upper side of the page in FIG. 9.

The connector tube 50A is provided with a pair of insertion holes 5h. The first terminal 6 (FIG. 3) is inserted into each insertion hole 5h. The connector tube 50A is provided with engaging recesses 56 that communicate with the insertion holes 5h from the outer circumferential surface. The engaging recesses 56 engage with an engaging tab 63 (FIG. 14) of the first terminal 6 described later. The engaging recesses 56 are holes in the present example, but may also be indentations formed in the inner circumferential surface of the insertion holes 5h.

The base 50B is provided with a housing-side engaging parts 50E and a through-hole 57. The housing-side engaging parts 50E are used to join the housing 50 and the cover 51. The housing-side engaging parts 50E in the present example are configured by holes penetrating through the base 50B. The through-hole 57 is provided at a position corresponding to the connection points between the first terminal 6 and the conductor 20 of the communication cable 2 illustrated in FIG. 3. The through-hole 57 is provided to ease the work of connecting the first terminal 6 and the conductor 20. The through-hole 57 is also used to join the housing 50 and the cover 51, similarly to the housing-side engaging parts 50E.

Unlike the present example, the housing-side engaging parts 50E may also be tabs rather than through-holes.

<<Cover>>

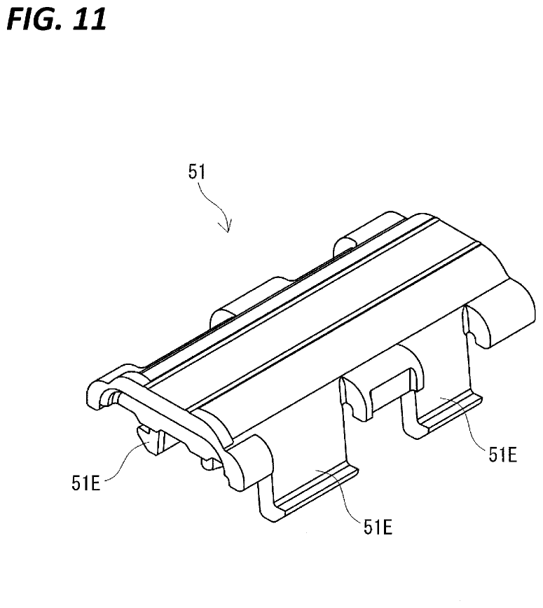

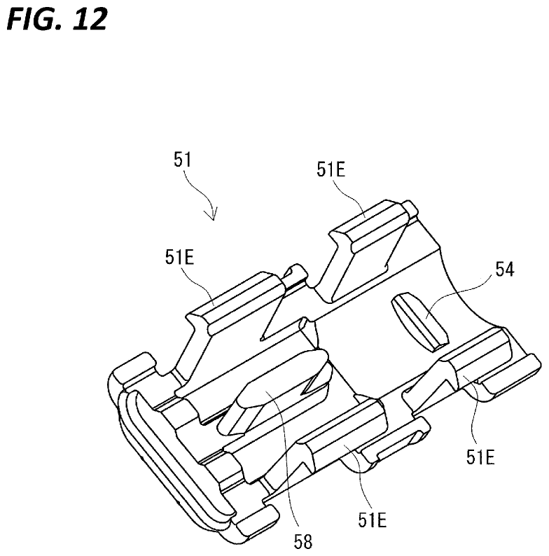

The cover 51 is a member that covers the opening in the base SOB of the housing 50 (FIGS. 2, 3). As illustrated in FIGS. 11 and 12, the cover 51 is provided with a plurality of cover-side engaging parts 51E. The cover-side engaging parts 51E in the present example are tabs. The cover-side engaging parts 51E formed as tabs are respectively fitted into the housing-side engaging parts 50E formed as holes and the through-hole 57 (see also FIG. 13). Due to the engagement of the tabs and the holes, the cover 51 is firmly secured to the housing 50.

Unlike the present example, the housing-side engaging parts 50E may be configured as tabs and the cover-side engaging parts 51E may be configured as holes.

The cover 51 is provided with a partition 58 as illustrated in FIG. 12. The partition 58 projects out from the inner circumferential surface of the cover 51. In the present example, since the communication cable 2 is a twisted-pair cable, two electric wires 2A, 2B are provided. For this reason, two connection points between the first terminal 6 and the conductor 20 of the communication cable 2 are provided side by side (see FIG. 3). The partition 58 is interposed between the connection points arranged side by side (see FIGS. 4 and 5). The interposition of the partition 58 ensures insulation between the connection points arranged side by side.

<<Configuration for Securing Communication Cable to Connector Member>>

As illustrated in FIGS. 9 and 12, the connector member 5 in the present example is internally provided with clamps 53 and 54. The clamp 53 is a portion of the connector member 5 that projects out from the inner circumferential surface of the housing 50 toward the communication cable 2 (FIG. 13). The clamp 54 is a portion of the connector member 5 that projects out from the inner circumferential surface of the cover 51 toward the communication cable 2 (FIG. 13).

Specifically, as illustrated in FIG. 9, the clamp 53 is provided on the inner circumferential surface of the base 50B of the housing 50. More specifically, the clamp 53 is provided in the floor portion of the base 50B that faces the shielding layer 23 (FIGS. 4 and 5) of the communication cable 2. The clamp 53 in the present example is a wide tab-shaped member that is long in the width direction of the base 50B. The amount by which the clamp 53 projects increases proceeding from the rim of the housing 50 toward the connector tube 50A. The shape of the clamp 53 as seen from the side is approximately a right triangle.

As illustrated in FIG. 12, the clamp 54 is provided in a portion of the inner circumferential surface of the cover 51 excluding the cover-side engaging parts 51E, at a position facing the clamp 53 (FIG. 9). The clamp 54 in the present example is a tab-shaped member of substantially the same width as the clamp 53. The amount by which the clamp 54 projects increases and then decreases proceeding from the rim of the cover 51 toward the partition 58. The inclination angle of the surface of the clamp 54 on the partition 58 side is greater than the inclination angle of the surface of the clamp 54 on the communication cable 2 side. The shape of the clamp 54 as seen from the side is approximately a scalene triangle.

FIG. 13 is a sectional view of the communication cable 1 with a connector taken in the direction orthogonal to the longitudinal direction at the position where the clamps 53 and 54 are provided. As illustrated in FIG. 13, the clamps 53 and 54 bite into the intervening layer 22 from the outer circumference of the shielding layer 23 of the communication cable 2. In the present example, notches 25 are provided in the intervening layer 22. The clamps 53 and 54 are fitted into each notch 25. Unlike the present example, the clamps 53 and 54 may also be configured to press against the outer circumference of the intervening layer 22 and bite into the intervening layer 22 when the housing 50 and the cover 51 are engaged. Regardless of whether the notches 25 exist, by having the clamps 53 and 54 bite into the communication cable 2, the connector member 5 is firmly secured to the end of the communication cable 2.

Note that even if the shielding layer 23 is deformed by the clamps 53 and 54, the shielding properties of the communication cable 1 with a connector are not lowered. This is because in the communication cable 1 with a connector in the present example, the outer circumference of the connector member 5 is covered by the shield member 4 that has excellent shielding properties.

In the configuration of the present example provided with the clamps 53 and 54 integrated into the connector member 5, a crimping ring is unnecessary. In a conventional communication cable with a connector, the communication cable and the connector member are engaged by a metal crimping ring. For details regarding this configuration, refer to Japanese Patent Laid-Open No. 2017-126408, for example. The crimping ring is attached to the outer circumference of the sheath of the communication cable. A portion of the crimping ring juts outward in the radial direction of the crimping ring. By fitting the jutting portion into notched grooves formed in the connector member, the communication cable and the connector member are engaged. In such a configuration using a crimping ring, the length of the connector member tends to be long. This is because the connector member needs to be long enough to cover the location where the crimping ring is provided on the sheath. Assuming the case of providing a crimping ring on the connector member 5 in the present example, the length of the connector member 5 would be approximately 23 mm.

Compared to the conventional connector member using a crimping ring, the connector member 5 in the present example is short. This is because in the connector member 5 in the present example, the clamps 53 and 54 grip the portion of the communication cable 2 where the sheath 24 is stripped. With a configuration in which the communication cable 2 is gripped by the clamps 53 and 54, the length of the connector member 5 can be kept to 22 mm or less, for example. If the length of the connector member 5 is short, the length of the shield member 4 covering the connector member 5 can also be short. If the length of the metal shield member 4 is short, the shield member 4 is more lightweight. For this reason, the connector module 3 is more lightweight to a corresponding degree compared to the conventional configuration described above. More preferably, the length of the connector member 5 is less than or equal to 20 mm. The lower limit on the length of the connector member 5 is approximately 10 mm, for example.

<<Configuration for Reinforcing Contact between Earth Terminal and Shield Member>>

As illustrated in FIG. 9, the connector member 5 is provided with the second guide parts 55 beside the insertion holes 5h. The second guide parts 55 have an inclined surface that inclines away from the shield member 4 proceeding toward the side of the connector member 5 from which the mating terminal is inserted (see also FIG. 4). Using the inclined surface as a guide, the earth terminal 10 can be inserted into the shield member 4. The base-end portion of the earth terminal 10 inserted into the shield member 4 contacts the overhanging part 44 provided in the shield member 4. The leading-end portion of the earth terminal 10 contacts the second guide part 55. The portion of the earth terminal 10 that is shifted in the longitudinal direction is pressed in opposite directions by the overhanging part 44 and the second guide part 55. As a result, the earth terminal 10 is firmly pressed against the overhanging part 44. Accordingly, even if the connector module 3 is subjected to vibrations in the case of being used in the automobile or the like, the electrical connection between the shield member 4 and the earth terminal 10 is ensured easily.

<<Securing Connector Member to Shield Member>>

As illustrated in FIGS. 4 and 5, the connector member 5 is provided with the connector-side engaging part 52. The connector-side engaging part 52 engages with the shield-side engaging part 42 of the shield member 4. As illustrated in FIG. 10, the connector-side engaging part 52 in the present example is provided on the outer circumferential surface of the housing 50. Specifically, the connector-side engaging part 52 includes an elastic protrusion 520 provided on the connector tube 50A and a stepped portion 521 provided on the base 50B.

The elastic protrusion 520 is supported in a cantilevered configuration on the trailing end, or in other words the end on the base 50B side, of an arched portion 59 provided on the outer circumferential surface of the connector tube 50A (see also FIG. 5). The surface of the elastic protrusion 520 on the leading side of the connector member 5, or in other words the surface on the opposite side from the base 50B, is an inclined surface. Additionally, the surface of the elastic protrusion 520 on the base 50B side is a perpendicular surface.

The stepped portion 521 is a locally thick portion of the base 50B. The surface of the stepped portion 521 on the leading side of the connector member 5 is a perpendicular surface.

Hereinafter, FIG. 5 will be referenced to describe the engaged state of the shield-side engaging part 42 and the connector-side engaging part 52.

The connector member 5 is inserted into the shield member 4 from the housing part 47 side. When the connector member 5 is inserted into the shield member 4, the elastic protrusion 520 contacts the shield-side engaging part 42 and is thereby pressed away from the shield member 4 and elastically deformed. When the connector member 5 inserted farther into the shield member 4, the stepped portion 521 of the connector member 5 is stopped by the shield-side engaging part 42. With this stopping, the insertion of the connector member 5 into the shield member 4 is complete. At this time, the elastic protrusion 520 gets over the shield-side engaging part 42 and returns to its original shape by its intrinsic elasticity. As a result, the shield-side engaging part 42 is caught between the elastic protrusion 520 and the stepped portion 521. By stopping the shield-side engaging part 42 against the elastic protrusion 520 and the stepped portion 521, the connector member 5 is firmly secured inside the shield member 4.

(First Terminal)

<Overview>

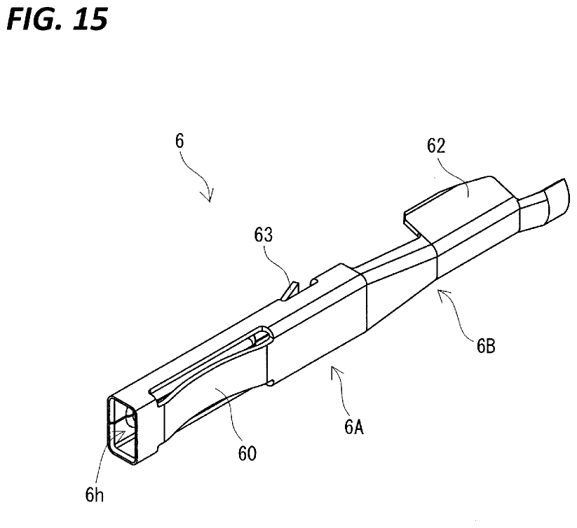

The first terminal 6 may be a male terminal or a female terminal. The first terminal 6 in the present example is a female terminal. Specifically, as illustrated in FIGS. 14 and 15, the first terminal 6 is provided with a tubular part 6A and a connecting part 6B. The tubular part 6A is provided with a terminal hole 6h into which a male mating terminal not illustrated is inserted. The female first terminal 6 and the male mating terminal are electrically connected through mechanical contact between the terminals. The female first terminal 6 is obtained by stamping a sheet material.

<Tubular part>

The tubular part 6A is provided with a flat spring 60. The flat spring 60 presses against the outer circumferential surface of the mating terminal inserted into the terminal hole 6h. In the present example, the outer circumferential surface of the tubular part 6A includes the outer surface of the flat spring 60. Specifically, as illustrated in FIG. 15, the flat spring 60 is formed by a portion of the tubular part 6A. More specifically, the tubular part 6A has a rectangular tube shape and is provided with four side surfaces. One of the side surfaces forming the tubular part 6A forms the flat spring 60. Accordingly, the outer surface of the flat spring 60 is exposed as the outer circumferential surface of the tubular part 6A. The end of the flat spring 60 on the terminal hole 6h side and the end of the flat spring 60 on the connecting part 6B side lead to another side surface forming the tubular part 6A. The two corner portions of the tubular part 6A sandwiching the flat spring 60 are punched out. Consequently, the tubular part 6A has respective through-holes in the two corner portions. The flat spring 60 is curved such that a central portion thereof in the axial direction of the tubular part 6A, or in other words the direction in which the mating terminal is inserted or removed, bulges inward into the tubular part 6A.

The tubular part 6A provided with the flat spring 60 is obtained easily by stamping. For example, the through-holes are provided by punching out the portions of the sheet material treated as the raw material of the first terminal 6 at the corner portions of the tubular part 6A. By bending the sheet material with the through-holes into a prescribed shape and curving the portion that is to act as the flat spring 60, the tubular part 6A including the flat spring 60 is formed. In a conventional female terminal, a flat spring is formed and then a tubular part is formed to surround the flat spring. For this reason, the outer surface of the flat spring is covered by a side surface of the tubular part. In contrast, in the first terminal 6 in the present example, the flat spring 60 itself forms a portion of the tubular part 6A. For this reason, forming the tubular part 6A to cover the flat spring 60 is unnecessary. Consequently, the first terminal 6 in the present example has superior manufacturability compared to a conventional female terminal.

The tubular part 6A is provided with a pressing portion 61 on the side surface that faces the flat spring 60 (FIG. 14). The pressing portion 61 is recessed inward into the tubular part 6A. The pressing portion 61 presses the mating terminal housed in the tubular part 6A against the flat spring 60. As a result, contact between the mating terminal and the flat spring 60 is ensured reliably. The pressing portion 61 can be formed at the same time as the flat spring 60 when stamping the tubular part 6A.

<Connecting Part>

The connecting part 6B is the portion that is connected to the conductor 20 (FIG. 3) of the communication cable 2. The connecting part 6B is provided with a wire barrel 62. The wire barrel 62 grips the conductor 20. By causing the wire barrel 62 to grip the conductor 20, the first terminal 6 and the conductor 20 are electrically connected. Here, the first terminal 6 in the present example is provided with only the wire barrel 62 as a barrel for gripping the outer circumference of the communication cable 2. A conventional female terminal is provided with an insulation barrel for gripping the sheath 24 of the communication cable 2, but the first terminal 6 in the present example is not provided with an insulation barrel.

<Engaging Part>

The first terminal 6 is provided with an engaging tab 63. The engaging tab 63 engages with an engaging recess 56 (FIG. 9) of the connector member 5. The engaging tab 63 is configured by making a cut in a portion of the sheet material forming the first terminal 6 and bending the cut portion. For this reason, the engaging tab 63 is elastic like a flat spring. The tip of the engaging tab 63 points toward the wire barrel 62. The first terminal 6 is inserted into an insertion hole 5h from the base SOB side of the connector member 5 (see FIG. 9). When the first terminal 6 is inserted into the insertion holes 5h, the engaging tab 63 is pressed against the inner circumferential surface of the insertion hole 5h and thereby elastically deformed inward into the tubular part 6A. When the first terminal 6 is inserted farther into the insertion hole 5h, the engaging tab 63 returns to its original shape by its intrinsic elasticity at a position corresponding to the engaging recess 56. The engaging tab 63 is caught in the engaging recess 56, thereby firmly securing the first terminal 6 to the connector member 5.

<Thickness>

The thickness of each part of the first terminal 6 is preferably less than or equal to 0.15 mm. If the thickness is less than or equal to 0.15 mm, a compact first terminal 6 is obtained easily. The shield member 4 formed from a casting as described above tends to be thicker compared to a stamped shield member. To avoid a bulky shield member 4, the connector member 5 and the first terminal 6 disposed inside the shield member 4 are preferably compact.

The thickness of each part of the first terminal 6 is preferably equal to or greater than 0.05 mm. If the thickness is equal to or greater than 0.05 mm, the strength of the first terminal 6 is ensured. The thickness is preferably equal to or greater than 0.075 mm and less than or equal to 0.13 mm, more preferably equal to or greater than 0.080 mm and less than or equal to 0.10 mm. The thickness here does not include the thickness of the edges obtained by bending the sheet material forming the first terminal 6.

<Constituent Material>

The constituent material of the first terminal 6 may be a material with excellent conductivity, typically a metal. Particularly, in the present example, the constituent material is preferably a material of superior strength. This is because, unlike a conventional female terminal, the first terminal 6 in the present example is not provided with a protective part covering the outer circumference of the flat spring 60. Stainless steel is one example of a material with excellent conductivity and superior strength. Stainless steel suitable for the first terminal 6 in the present example may be any of the following European standard steel numbers, for example. Among the steel numbers below, 1.4310 and 1.4318, for example, are preferable from the standpoint of conductivity and strength.

(European Standard Steel Numbers)

1.4372, 1.4373, 1.4310, 1.4318, 1.4305, 1.4307, 1.4306, 1.4311, 1.4303, 1.4401, 1.4436, 1.4404, 1.4432, 1.4435, 1.4406, 1.4429, 1.4571, 1.4438, 1.4434, 1.4439, 1.4539, 1.4541, 1.4550, 1.4587, 1.4381, 1.4462, 1.4507, 1.4002, etc.

The surface of the first terminal 6 is preferably provided with a plating layer formed from a material with excellent conductivity. The constituent material of the plating may be tin (Sn), silver (Ag), or an alloy thereof, for example.

The first terminal 6 in the present example is not provided with a configuration for covering the outer portions of the flat spring 60 and the pressing portion 61, and therefore has a simpler configuration than a conventional female terminal. For this reason, when manufacturing the tubular part 6A by stamping, the flat spring 60 and the pressing portion 61 can be formed at the same time. The first terminal 6 in the present example as above can be produced more easily than a conventional female terminal.

[Connector Assembly]

Hereinafter, FIG. 4 will be referenced mainly to describe a connector assembly 9 according to Embodiment 1.

The connector assembly 9 of Embodiment 1 is provided with the communication cable 1 with a connector of Embodiment 1, a watertight plug 30, and an outer housing 90. The watertight plug 30 is a tubular member mounted onto the outer circumferential surface of the sheath 24 of the communication cable 2. The outer housing 90 houses the end of the communication cable 1 with a connector and the watertight plug 30. In FIG. 4, the outer housing 90 is illustrated virtually with chain double-dashed lines.

Hereinafter, the watertight plug 30 will be described. The outer housing 90 will be described in detail in Modification 5.

(Watertight Plug)

The watertight plug 30 is a rubber member formed from any of the various types of rubber materials described in the <<Constituent material>> section regarding the conductive rubber member 7. The watertight plug 30 has a function of keeping the shielding layer 23 from being exposed to environmental water. In the present example, the watertight plug 30 is disposed throughout the portion of the outer circumferential surface of the shielding layer 23 exposed in the communication cable 2 from the stripped end on the outer circumferential surface of the sheath 24. In other words, the watertight plug 30 is disposed to straddle the shielding layer 23 and the sheath 24. Also, in the present example, the watertight plug 30 is disposed to press the trailing end face of the conductive rubber member 7 toward the leading end in the longitudinal direction of the conductive rubber member 7. For this reason, the end face of the watertight plug 30 closely contacts the trailing end face of the conductive rubber member 7 exposed from the housing part 47. Note that environmental water includes moisture in the air.

The watertight plug 30 is provided with a cable hole 30h. The communication cable 2 is inserted into the cable hole 30h. The cable hole 30h has a narrow-diameter portion h1 and a wide-diameter portion h2 with a larger inner diameter than the narrow-diameter portion h1. A stepped portion is provided between the narrow-diameter portion h1 and the wide-diameter portion h2. In the state in which the watertight plug 30 is not mounted onto the communication cable 2, or in other words not elastically deformed, the inner diameter of the narrow-diameter portion h1 is less than the outer diameter of the shielding layer 23. Also, the inner diameter of the wide-diameter portion h2 is less than the outer diameter of the sheath 24.

In the state in which the watertight plug 30 is mounted onto the communication cable 2, the narrow-diameter portion h1 is disposed on the exposed shielding layer 23 and the wide-diameter portion h2 is disposed on the sheath 24. With this arrangement, elastic shrinkage of the narrow-diameter portion h1 causes the inner circumferential surface of the narrow-diameter portion h1 to closely contact the shielding layer 23. Also, the inner circumferential surface of the wide-diameter portion h2 closely contacts the sheath 24. The end face of the sheath 24 is caught on the stepped portion described above. In other words, the watertight plug 30 in the present example has a structure that is directly assembled with the communication cable 2. For this reason, in the connector assembly 9 in the present example, a separate holder for fixing the watertight plug 30 at a desired position is unnecessary. Additionally, the watertight plug 30 is disposed to straddle the shielding layer 23 and the sheath 24 of the communication cable 2. For this reason, in the connector assembly 9 in the present example, the length of the communication cable 2 in the axial direction is shortened more easily compared to the case where the watertight plug 30 is disposed on only the sheath 24. In view of this feature, the connector assembly 9 in the present example is compact.

Annular ridges 30p are provided on the outer circumferential surface of the watertight plug 30. The ridges 30p are provided at positions farther outward than the outer circumferential surface of the shield member 4. Accordingly, in the watertight plug 30, at least the ridges 30p have a maximum outer diameter that is greater than the maximum outer diameter Rmax of the conductive rubber member 7.

In the state in which the communication cable 1 with a connector is housed in the outer housing 90, the ridges 30p of the watertight plug 30 are pressed against the inner circumferential surface of a wall 90A and thereby closely contact the inner circumferential surface. Due to this close contact, the watertight plug 30 deters the entry of environmental water into the connector module 3 from gaps between the communication cable 1 with a connector and the outer housing 90. Note that the inner circumferential surface of the wall 90A forms a housing region for the communication cable 1 with a connector in the outer housing 90. FIG. 4 illustrates a state in which the ridges 30p are not being pressed by the wall 90A.

(Major Effects)

The connector module 3 of Embodiment 1, the communication cable 1 with a connector of Embodiment 1, and the connector assembly 9 of Embodiment 1 are exceptionally easy to assemble due to (a) and (b) below. Furthermore, the connector module 3 of Embodiment 1, the communication cable 1 with a connector of Embodiment 1, and the connector assembly 9 of Embodiment 1 also exhibit excellent electromagnetic shielding properties due to (c) below.

(a) The conductive rubber member 7 is easily disposed on the outer circumference of the shielding layer 23.

(b) The conductive rubber member 7 easily enters the housing part 47 from the opening 46 in the housing part 47.

(c) The conductive rubber member 7 closely contacts both the outer circumferential surface of the shielding layer 23 of the communication cable 2 and the inner circumferential surface of the housing part 47.

The feature (a) will be described. The conductive rubber member 7 is elastic. Accordingly, by radially expanding the conductive rubber member 7, the conductive rubber member 7 can be fitted easily onto the outer circumference of the shielding layer 23 of the communication cable 2.

The feature (b) will be described. The maximum outer diameter Rmax of the conductive rubber member 7 satisfies the specific size described above. Accordingly, the conductive rubber member 7 enters the housing part 47 from the opening 46 more easily compared to the case where the opening 46 and the nearby inner dimension of the housing part 47 are the minimum inner dimension Smin, for example. This is because at the opening 46 and the nearby portion of the housing part 47, the conductive rubber member 7 is not pressed by the housing part 47 or the degree of pressing is low. Also, the housing part 47 is provided with the specific inclined surface 470 described above. Accordingly, as the conductive rubber member 7 proceeds inward into the housing part 47 from the opening 46, the conductive rubber member 7 is gradually pressed by the inclined surface 470, but the inclined surface 470 also acts as a guide to allow easy entry into the housing part 47. In particular, the inclined surface 470 in the present example is configured as a flat surface except for the groove 472. Accordingly, the conductive rubber member 7 easily enters along the inclined surface 470 compared to Modification 2 described later.

The feature (c) will be described. By causing the conductive rubber member 7 to closely contact both the shielding layer 23 and the inclined surface 470, an electrical connection through the three components of the shielding layer 23, the conductive rubber member 7, and the shield member 4 is ensured. Accordingly, a favorable conductive pathway through the three components is established. In the present example, a large contact area between the conductive rubber member 7 and the shield member 4 is ensured due to (A) to (E) below. Accordingly, the conductive pathway is established more reliably. Consequently, by grounding the shield member 4 with the earth terminal 10, the shielding layer 23 is grounded through the conductive rubber member 7 and the shield member 4. As a result, an induced current generated in the shielding layer 23 can flow to ground. Moreover, the grounding prevents electrification of the shield member 4 itself.

(A) The housing part 47 is provided with a plurality of inclined surfaces 470.

(B) Each inclined surface 470 is provided with a plurality of grooves 472.

(C) Each inclined surface 470 is continuous from the opening 46 in the housing part 47 to the inner end 474 described above.

(D) The conductive rubber member 7 contains silicone.

(E) The conductive rubber member 7 is a cylindrical material.

In the present example, the effects of (a) to (c) above are also obtained easily because the inclusion of silicone in the conductive rubber member 7 allows for easy elastic deformation.

The connector module 3, the communication cable 1 with a connector, and the connector assembly 9 in the present example further exhibit the following effects.

(1) The conductive rubber member 7 is sandwiched between two inclined surfaces 470 disposed facing each other, and also worked into the plurality of grooves 472 provided in each of the inclined surfaces 470. Accordingly, the conductive rubber member 7 is firmly held in the shield member 4. Even if the connector module 3 and the like are subjected to vibration in the case of being used in the automobile or the like, the conductive rubber member 7 does not slip off the shield member 4 easily. Consequently, a separate rear holder for the shield member 4 is unnecessary. In the first terminal 6, a structure that can hold the conductive rubber member 7 is unnecessary. In view of these features, a further improvement in ease of assembly can be expected.

(2) The shape of the inclined surface 470 including the groove 472 is a shape that is moldable in a mold. Such a shield member 4 has excellent manufacturability.

(3) The conductive rubber member 7 is an extrusion-molded article having a simple, cylindrical shape. Accordingly, the conductive rubber member 7 can be mass-produced. In view of this feature, manufacturing costs can be lowered compared to the case where the conductive rubber member 7 is molded in a mold.

(4) The shield member 4 is not an assembly of multiple pieces but rather a singular casting, and therefore easily attached to the connector member 5. Also, the shield member 4 formed from a casting can be attached to the connector member 5 precisely. In the case where the shield member 4 is the above assembly, for example, there may be a stamping tolerance when stamping and an assembly tolerance when assembling two stamped articles. As a result of these tolerances, the attachment precision of the shield member 4 with respect to the connector member 5 tends to be lower. In contrast, in the shield member 4 formed from a casting, there is only the casting tolerance when casting the shield member 4, and there is no assembly tolerance. The shield member 4 in the present example has fewer tolerances than the above assembly, and therefore the attachment precision with respect to the connector member 5 is raised. In view of these features, a further improvement in ease of assembly can be expected.

Furthermore, in the shield member 4 which is a singular casting, there are no holes penetrating through the inside and outside of the shield member 4 on the circumferential surface of the shield member 4. In other words, there are no holes due to seams between pieces. Electromagnetic waves do not leak out from the holes, and therefore the shield member 4 has superior electromagnetic shielding properties. Note that the above assembly is configured by combining two stamped articles obtained by stamping a sheet material. One example of the assembly is the outer conductor in Patent Document 1.

(5) The connector member 5 is provided with the clamps 53 and 54 and therefore is firmly secured to the end of the communication cable 2. Since a crimping ring is unnecessary, the number of parts forming the communication cable 1 with a connector and the steps for assembling the parts are reduced. In view of this feature, a further improvement in ease of assembly can be expected. The productivity, including cost, of the communication cable 1 with a connector and the like is also improved. Furthermore, even if the connector module 3 and the like are subjected to vibration in the case of being used in the automobile or the like, the connector member 5 does not slip off the end of the communication cable 2 easily.

(6) In the connector assembly 9, a holder for the watertight plug 30 is unnecessary. In view of this feature, a further improvement in ease of assembly can be expected. The productivity, including cost, of the connector assembly 9 is also improved.

Hereinafter, modifications will be described. Note that Modifications 1 to 3 are omitted from illustration in the drawings.

[Modification 1]

The inclined surface 470 may be the entire inner circumferential surface rather than a portion of the inner circumferential surface of the housing part 47. In other words, the inner circumferential surface of the housing part 47 may be a frustum shape such that the cross-sectional area of the housing part 47 decreases proceeding inward into the tubular body 4A from the opening 46. In this case, the grooves 472 may be provided only in a prescribed range in the circumferential direction of the inner circumferential surface. Alternatively, the grooves 472 may be provided with a prescribed spacing, such as equal spacing, for example, in the circumferential direction of the inner circumferential surface. In this case, the inner circumferential surface has a repeating shape of periodic irregularities in the circumferential direction of the inner circumferential surface, that is, a shape like an internal gear, so to speak.

[Modification 2]

The inclined surface 470 does not have to be provided with the grooves 472. In this case, the inclined surface 470 may not be a single flat surface proceeding inward into the tubular body 4A from the opening 46, for example, but rather formed from multi-step surfaces in which the steps rise proceeding inward into the tubular body 4A from the opening 46, for example. In the multi-step inclined surface 470, the stepped portion bites into the conductive rubber member 7. Due to this biting, the conductive rubber member 7 is expected to not slip off the shield member 4 as easily compared to the case of a flat surface described above.

[Modification 3]

The conductive rubber member 7 may be provided with a plurality of ridges that touch the inner circumferential surface of the housing part 47, for example, and also have a uniform cross-sectional shape in the axial direction of the conductive rubber member 7. A uniform cross-sectional shape in the axial direction means that when a cross section of the conductive rubber member 7 is taken at any position in the axial direction of the conductive rubber member 7, the shape is geometrically congruent for all cross sections. In other words, a plurality of ridges arranged side by side are provided in the circumferential direction of the conductive rubber member 7, continuously or intermittently from one end of the conductive rubber member 7 to the other end. This conductive rubber member 7 has a shape like an external gear, so to speak.

[Modification 4]

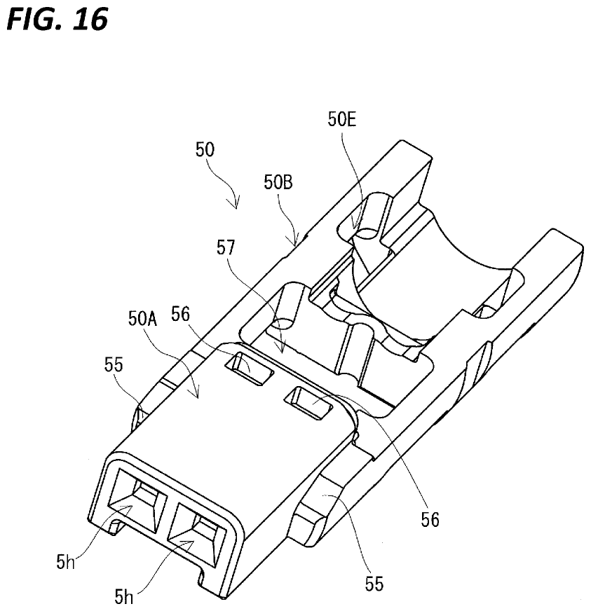

In the connector member 5 provided in the communication cable 1 with a connector, a configuration different from the clamps 53 and 54 described in Embodiment 1 will be described on the basis of FIGS. 16 to 18.

FIG. 16 is a perspective view of the housing 50 of the connector member 5 as seen from the inner circumferential side.

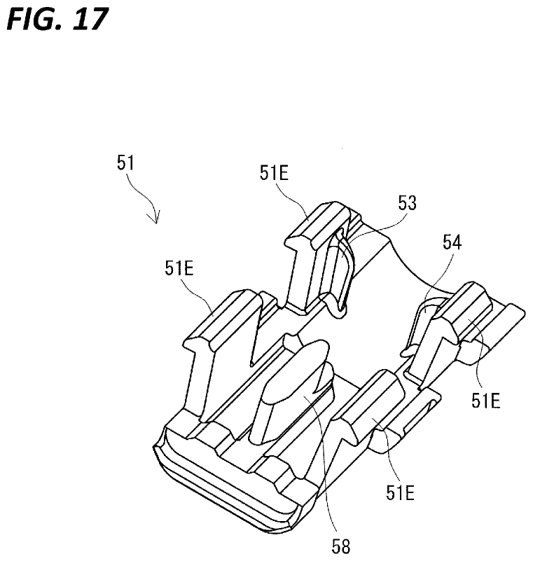

FIG. 17 is a perspective view of the cover 51 of the connector member 5 as seen from the inner circumferential side.

FIG. 18 is a sectional view of the communication cable 1 with a connector taken in the direction orthogonal to the longitudinal direction at the position where the clamps 53 and 54 are provided.

As illustrated in FIG. 16, the housing 50 in the present example is not provided with a clamp on the inner circumferential surface of the base 50B. As illustrated in FIG. 17, the cover 51 in the present example is provided with a pair of clamps 53 and 54 on the inner circumferential surface thereof. The clamps 53 and 54 are provided apart from each other in the width direction of the cover 51. Specifically, the clamp 53 is provided on the inner circumferential surface of a first cover-side engaging part 51E of the pair of cover-side engaging parts 51E on the trailing end side of the cover 51. The clamp 54 is provided on the inner circumferential surface of a second cover-side engaging part 51E. The clamps 53 and 54 are both integrally joined to the cover 51. Accordingly, the clamps 53 and 54 also function as reinforcing members for the cover-side engaging parts 51E.

The clamps 53 and 54 are curved plate-like members. Each curved plate is provided so as to be convex in the opposite direction from the partition 58. The leading ends of the clamps 53 and 54 are disposed closer to the partition 58 than the bases of the clamps 53 and 54, which is the diagonally lower side of the page in FIG. 17. Also, the leading ends of the clamps 53 and 54 are disposed pointing toward the first terminal 6 (FIG. 3).

As illustrated in FIG. 18, in the communication cable 1 with a connector using the connector member 5 of the present example, the clamps 53 and 54 provided on the cover 51 catch the communication cable 2 from the outer circumference. At this time, the clamps 53 and 54 bite into the notches 25 provided in the intervening layer 22. With this configuration, too, the connector member 5 is firmly secured on the end of the communication cable 2. In the present example, the thickness of the clamps 53 and 54 decreases proceeding from the bases to the tips of the clamps 53 and 54. For this reason, the clamps 53 and 54 easily bite into the notches 25.

[Modification 5]

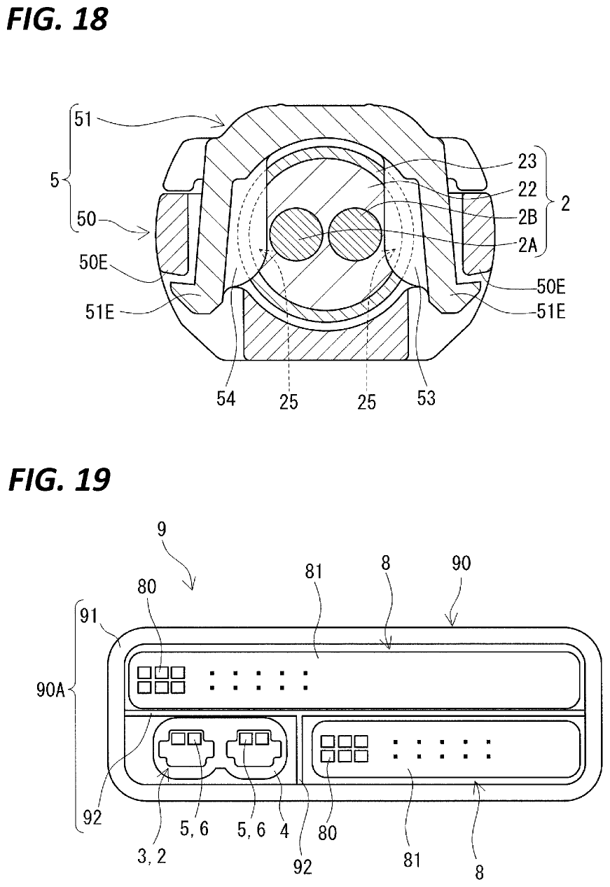

A modification of the connector assembly 9 provided with the communication cable 1 with a connector of Embodiment 1 will be described on the basis of FIG. 19.

FIG. 19 is a schematic front view of the connector assembly 9 as seen from the side on which terminals 6 and 80 are exposed. The connector assembly 9 in the present example is provided with the communication cable 1 with a connector of Embodiment 1, a signal cable unit 8, and an outer housing 90.

The signal cable unit 8 is provided with a signal cable not illustrated, a plurality of second terminals 80, and an inner housing 81. The signal cable transmits electrical signals. The inner housing 81 houses the plurality of second terminals 80. In the present example, the first terminals 6 are female terminals, and therefore the second terminals 80 are also female terminals. In the case where the first terminals 6 are male terminals, the second terminals 80 are also male terminals. The outer housing 90 in the present example collectively houses the communication cable 1 with a connector and the ends of the signal cable unit 8. Particularly, in the present example, the outer housing 90 collectively houses the connector module 3 of the communication cable 1 with a connector and the inner housing 81 of the signal cable unit 8.

The outer housing 90 in the present example is provided with a tubular part 91 and a partition 92. The tubular part 91 forms the exterior of the outer housing 90. The partition 92 divides the interior of the tubular part 91 into multiple sections. In the outer housing 90 of the present example, by partitioning the interior of the tubular part 91 with the partition 92, a space housing the communication cable 1 with a connector and a space housing the signal cable unit 8 are provided.

The connector assembly 9 provided with the communication cable 1 with a connector makes it easy to construct a communication environment in an automobile. By connecting the connector assembly 9 in the present example to a male connector assembly not illustrated which is provided on a circuit board of an in-vehicle device, a transmission route for the signal cable and a transmission route for the communication cable 2 are established at the same time.

When the communication cable 1 with a connector is housed in the outer housing 90 of the present example, the ridges 30p (FIGS. 1, 4, 5) of the watertight plug 30 closely contact the inner circumferential surface of the wall 90A. The inner circumferential surface of the wall 90A is formed by the tubular part 91 and the partition 92. The close contact between the ridges 30p and the wall 90A deters the entry of environmental water into the connector module 3 from gaps between the communication cable 1 with a connector and the outer housing 90.

The total number of first terminals 6 and second terminals 80, or in other words the number of poles, is preferably equal to or greater than 20 and less than or equal to 200. If the number of poles is equal to or greater than 20, many transmission routes are established at once through the connection with the connector assembly 9. If the number of poles is less than or equal to 200, the connection resistance when connecting the female connector assembly 9 of the present example to a male connector assembly is not overly high. Accordingly, the connector assemblies are connected easily.

The pitch of the second terminals 80 is preferably equal to or greater than 0.1 mm and less than or equal to 2.0 mm. If the pitch of the second terminals 80 is within this range, a compact connector assembly 9 is obtained easily. If the connector assembly 9 is compact, a connector assembly 9 of a size corresponding to a male connector assembly provided on a circuit board can be produced.

### LIST OF REFERENCE NUMERALS

1: communication cable with a connector

2: communication cable
2A, 2B: electric wire
20: conductor, 21: insulating layer, 22: intervening layer
23: shielding layer, 24: sheath, 25: notch

3: connector module
30: watertight plug, 30p: ridge
30h: cable hole, h1: narrow-diameter portion, h2: wide-diameter portion

4: shield member
4A: tubular body, 4B: connecting part
40, 46: opening, 41: first guide parts
42: shield-side engaging part, 43: thick-walled section, 44: overhanging part
47: housing part, 470: inclined surface, 472: groove
473, 474: end

5: connector member
5h: insertion hole
50: housing, 50A: connector tube, 50B: base
50E: housing-side engaging part
51: cover, 51E: cover-side engaging part
52: connector-side engaging part, 520: elastic protrusion, 521: stepped portion
53, 54: clamp, 55: second guide part
56: engaging recess, 57: through-hole, 58: partition
59: arched portion

6: first terminal
6A: tubular part, 6B: connecting part, 6h: terminal hole
60: flat spring, 61: pressing portion, 62: wire barrel
63: engaging tab

7: conductive rubber member
7h: cable hole
8: signal cable unit
80: second terminal, 81: inner housing

9: connector assembly
90: outer housing, 90A: wall
91: tubular part, 92: partition

10: earth terminal

Rmax: maximum outer diameter, Smin: minimum inner dimension, Smax: maximum inner dimension

1. a connector module provided on an end of a communication cable, the connector module comprising:
a first terminal;
a connector member that houses the first terminal;
a tubular shield member that covers the outer circumference of the connector member; and
a tubular conductive rubber member disposed in contact with the inner circumferential surface of the shield member, wherein
the shield member comprises a housing part in which the conductive rubber member is disposed on the side where the end of the communication cable is inserted,
the maximum outer diameter of the conductive rubber member when not compressed by the housing part exceeds the minimum inner dimension of the housing part and is equal to or less than the maximum inner dimension of an opening in the housing part,
at least a portion of the inner circumferential surface of the housing part comprises an inclined surface, and
the inclined surface is inclined such that the inner dimension of the housing part decreases in size proceeding inward into the shield member from the opening.

2. The connector module according to claim 1, wherein
the housing part has at least one groove provided in the inclined surface, and
the groove has a shape extending along the axial direction of the shield member.

3. The connector module according to claim 2, wherein the inner circumferential surface comprises a plurality of inclined surfaces spaced apart in the circumferential direction of the inner circumferential surface.

4. The connector module according to claim 3, wherein the inner circumferential surface comprises two inclined surfaces facing each other.

5. The connector module according to claim 1 4, wherein the conductive rubber member is a cylindrical material having a uniform outer diameter.

6. The connector module according to claim 5, wherein the conductive rubber member is an extrusion-molded article.

7. The connector module according to claim 1, wherein the conductive rubber member contains silicone rubber.

8. The connector module according to claim 7, wherein the conductive rubber member contains a conductive filler.

9. The connector module according to claim 1, wherein the shield member is a casting.

10. A communication cable with a connector, comprising:
the connector module according to claim 1; and
a communication cable, wherein
the communication cable comprises a conductor, an insulating layer, a shielding layer, and a sheath in order from the inside out,
the first terminal is connected to the conductor, and
the conductive rubber member is disposed in contact with the shielding layer.

11. The communication cable with a connector according to claim 10, wherein
the first terminal comprises a tubular part that accepts the insertion of a male terminal and a connecting part connected to the conductor,
the tubular part comprises a flat spring that presses against the outer circumferential surface of the male terminal inserted into the tubular part, and
the outer circumferential surface of the tubular part includes the outer surface of the flat spring.

12. The communication cable with a connector according to claim 10, wherein the communication cable is a shielded twisted-pair cable.

13. The communication cable with a connector according to claim 10, wherein
a constituent material of the connector member is a resin,
the connector member comprises a clamp that bites into the communication cable, and
the clamp projects out from the inner circumferential surface of the connector member toward the communication cable.

14. A connector assembly comprising:
the communication cable with a connector according to claim 10;
a tubular watertight plug mounted onto the outer circumferential surface of the sheath; and
an outer housing that houses the end of the communication cable with a connector and the watertight plug.

15. The connector assembly according to claim 14, wherein
the watertight plug comprises a cable hole through which the communication cable is inserted,
the cable hole has a narrow-diameter portion that closely contacts the shielding layer and a wide-diameter portion that closely contacts the sheath, and
the end face of the sheath is caught on a step between the narrow-diameter portion and the wide-diameter portion.
